(19) United States
(12) Patent Application Publication
(10) Pub. No.: US 2006/0190290 A1
(43) Pub. Date: Aug. 24, 2006

(54) Systems and methods for distributing electronic files

(75) Inventor: Tomy M. Gomez, Riverdale, NY (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Brainshield Technologies, Inc.

(21) Appl. No.: 11/353,305

(22) Filed: Feb. 13, 2006

Related U.S. Application Data
(60) Provisional application No. 60/655,345, filed on Feb. 22, 2005.

(51) Int. Cl. G06Q 99/00; H04K 1/00; H04L 9/00

(52) U.S. Cl. 705/1; 705/80

(57) ABSTRACT

An electronic content exchange system according to various embodiments of the invention is configured for super distribution of digital media data such as music, movies, games, software, and other copyrighted materials from content owners to consumers, while enabling content owners to retain control of their digital media assets. In certain embodiments, the system includes a supply chain platform to enable delivery of digital content to consumers across multiple services, networks, devices, and payment options. Furthermore, in particular embodiments, the system is a trade exchange, offers content owners an open marketplace for digital media data aggregation where multiple content owners may list digital media data and demand matching occurs across multiple digital media sources and retail outlets. Various embodiments of the system provide content tracking and protection to enable real-time commodity-oriented business models, while giving end users the accessibility and portability for content they have purchased.

### CROSS REFERENCE TO RELATED APPLICATIONS

This application claims priority from provisional application No. 60/655,345 entitled “Systems and Methods for Distributing Electronic Files”, which was filed Feb. 22, 2005 and which is hereby incorporated by reference.

### BACKGROUND OF THE INVENTION

The use of the Internet and the World Wide Web for distribution of digital media data has focused primarily on the protection of the digital media from unauthorized use, while inhibiting the ability of content owners to provide a seamless and transparent platform for the provisioning of content in digital format. The primary reasons for the restrictive nature of existing solutions is the inability to transpose the existing contractual obligations of content owners over digital delivery networks and provisioning systems. Many existing systems, while focusing on restricting the reproduction of digital media data to accommodate for contractual obligations, impede the ability to provision digital media data into supply chains without restricting distribution to consumers. Existing systems for provisioning are typically static in nature and do not provide the ability to create a commodity oriented real-time business model. Furthermore, many existing provisioning systems do not support interoperability, transportability, and portability of the digital media data in a legal manner.

A further aspect of many existing provisioning systems is the inability to track content uniquely for each instance of supply chain consumption, and each instance of end-user (e.g., consumer) consumption.

### BRIEF SUMMARY OF VARIOUS EMBODIMENTS OF THE INVENTION

Various embodiments of a system for distributing of digital files over communications networks (e.g., public communication networks) are disclosed herein. Such systems may be referred to, for example, as “the digital exchange”, “the exchange”, “the system”, “the Digital-T exchange”, or “the electronic content exchange system”. Digital files may include, for example, any written, aural, graphical or video based work including computer software that has been translated to or created in digital form, and which can be recreated using suitable rendering means such as software programs.

Various embodiments of the present invention enable distribution of digital works from the owner of the works to end users, while enabling owners to dynamically retain control over the business rules of their digital works. In one embodiment, the system includes a supply chain platform to enable delivery of digital content to consumers across multiple services, networks, devices, and payment options. In this embodiment, the system is a trade exchange, offers content owners an open marketplace for aggregation of digital works where multiple owners may list digital works, and demand matching occurs across multiple digital work sources and retail outlets. In this embodiment, the system provides digital work tracking and protection to enable real-time commodity-oriented business models, while providing end users accessibility and portability for the digital works they have purchased. Various embodiments of the invention are configured so that, once they are adopted by content owners, other service providers, resellers, syndicators, and retailers will only have to write a single interface, rather than a different one for each commerce partner. In one embodiment, the system includes a service control infrastructure that offers transparencies to end-users and content owners with respect to both the domains and the underlying distribution technologies.

In one embodiment, the online system includes one or more of the following general components: (1) a content preparation, ingestion and listing capability; (2) a federated catalog/order management capability; (3) a retail sales capability; (4) a secure content distribution capability; (5) an accounting, clearing, and reporting capability; and (6) an affiliate syndication capability.

In various embodiments, the system described above may be used to facilitate various inventive methods. Several of such methods are summarized below. As will be understood by one skilled in the relevant field in light of this disclosure, some or all of the steps of the various methods described herein may be executed by an appropriate computer system. Computer-executable instructions for implementing one or more of these steps may be stored on an appropriate computer-readable medium.

A method of distributing electronic media files according to one embodiment of the invention includes the steps of: (1) providing a set of electronic media files at a central electronic media exchange; (2) establishing a first class of customers; (3) establishing a first set of contractual terms according to which the first class of customers will be allowed to purchase copies of the electronic media files from the electronic media exchange; (4) establishing a second class of customers; (5) establishing a second set of contractual terms according to which the second class of customers will be allowed to purchase copies of the electronic media files from the electronic media exchange; (6) selling copies of the electronic media files to at least one customer within the first class of customers according to the first set of contractual terms; and (7) selling copies of the electronic media files to at least one customer within the second class of customers according to the second set of contractual terms. In one embodiment, the first class of customers comprises a first plurality of retailers, and the second class of customers comprises a second plurality of retailers.

In a particular embodiment of the invention, the step of establishing a first set of contractual terms comprises establishing a first set of contractual terms according to which the first class of customers will be allowed to purchase copies of the electronic media files for resale. Similarly, in one embodiment of the invention, the step of establishing a second set of contractual terms comprises establishing a second set of contractual terms according to which the second class of customers will be allowed to purchase copies of the electronic media files for resale. This second set of contractual terms may be different from the first set of contractual terms.

A method of providing a set of electronic media files according to a further embodiment of the invention includes the steps of: (1) providing a set of electronic media files at a central electronic media exchange; (2) allowing a first retailer to sell transmissions of the electronic media files from the central media exchange via a first front end; and (3) allowing a second retailer to sell transmissions of the electronic media files from the central media exchange via a second front end. In a particular embodiment, the method further includes the step of, in response to a first file being purchased for transmission via the first front end, associating a first set of source-identifier data with the first file, the first set of source-identifier data identifying the first retailer as a source of the first file. In yet another embodiment of the invention, the method further includes the step of, in response to the first file being purchased for transmission via the first front end, associating, with the first file, a first set of usage rules established by the first retailer, the usage rules being used to limit the usage of the first file after the first file is transmitted via the first front end.

In a particular embodiment, the method also includes the step of, in response to a second file being purchased for transmission via the second front end, associating, with the second file, a second set of usage rules, the second set of usage rules having been established by the second retailer and being used to limit the usage of the second file after the second file is transmitted via the second front end. In yet another embodiment of the invention, the method also includes the step of, in response to a second file being purchased for transmission via the second front end, associating a second set of source-identifier data with the second file, the second set of source-identifier data identifying the second retailer as a source of the second file.

A method of distributing electronic media files includes the steps of: (1) providing a first set of electronic media files at a central electronic media exchange, the first set of electronic media files being owned by a first media owner; (2) providing a second set of electronic media files at a central electronic media exchange, the second set of electronic media files being owned by a second media owner; (3) allowing the first media owner to establish a first set of rules according to which copies of each of the first set of electronic media files will be sold to retailers for transfer from the central electronic media exchange; (4) allowing the second media owner to establish a second set of rules according to which copies of each of the second set of electronic media files will be sold to retailers for transmission via the central electronic media exchange; (5) selling, according to the first set of rules, a copy of at least one of the first set of electronic media files to a first retailer for transfer from the electronic media exchange; and (6) selling, according to the second set of rules, a copy of at least one of the second set of electronic media files to a second retailer for transfer from the electronic media exchange.

In one embodiment, the first set of rules includes: (1) a first subset of rules according to which copies of one or more of the first set of electronic media files will be sold to a first set of retailers for transfer from the central electronic media exchange; and (2) a second subset of rules according to which copies of one or more of the first set of electronic media files will be sold to a second set of retailers for transfer from the central electronic media exchange. In a particular embodiment, the first and second subsets of rules are defined by the first media owner. Similarly, in one embodiment, the first and second sets of customers are defined by the first media owner.

In a particular embodiment of the invention, the second set of rules comprises: (1) a third subset of rules according to which copies of one or more of the second set of electronic media files will be sold to a third set of retailers for transfer from the central electronic media exchange; and (2) a fourth subset of rules according to which copies of one or more of the second set of electronic media files will be sold to a fourth set of retailers for transfer from the central electronic media exchange. In one embodiment of the invention, the first and second subsets of rules are defined by the first media owner, and the third and fourth subsets of rules are defined by the second media owner. Similarly, in a particular embodiment of the invention, the first and second sets of customers are defined by the first media owner, and the third and fourth sets of customers are defined by the second media owner.

A method of distributing electronic media files according to a further embodiment of the invention includes the steps of: (1) providing a set of electronic media files at a central electronic media exchange, the set of files being owned by a media owner; (2) allowing a first retailer to sell transfers of one or more of the set of electronic media files from the central media exchange via a first front end; (3) allowing a second retailer to sell transfers of the electronic media files from the central media exchange via a second front end; (4) reporting, to the media owner in real time, data indicating how many copies of each of the set of electronic media files has been sold by the first retailer within a particular period of time; and (5) reporting, to the media owner in real time, data indicating how many copies of each of the set of electronic media files has been sold by the second retailer within the particular period of time. In a particular embodiment of the invention, the method further includes the steps of: (1) providing a second set of electronic media files at the central electronic media exchange, the second set of files being owned by a second media owner; (2) allowing a first retailer to sell transfers of one or more of the second set of electronic media files from the central media exchange via the first front end; (3) allowing a second retailer to sell transfers of one or more of the second set of electronic media files from the central media exchange via the second front end; (4) reporting, to the second media owner in real time, data indicating how many copies of each of the second set of electronic media files has been sold by the first retailer within a particular period of time; and (5) reporting, to the second media owner in real time, data indicating how many copies of each of the second set of electronic media files has been sold by the second retailer within the particular period of time.

A method of distributing electronic media files according to yet another embodiment of the invention comprises the steps of: (1) providing a set of electronic media files at a central electronic media exchange, the set of files being owned by a media owner; (2) allowing a first retailer to sell transfers of one or more of the set of electronic media files from the central media exchange via a first front end; (3) allowing a second retailer to sell transfers of one or more of the set of electronic media files from the central media exchange via a second front end; (4) reporting, to the media owner in real time, data indicating how many copies of each of the set of electronic media files has been sold by the first retailer within a particular period of time; and (5) reporting, to the media owner in real time, data indicating how many copies of each of the set of electronic media files has been sold by the second retailer within the particular period of time. In a particular embodiment, the method further comprises allowing the media owner to change, in real time (or substantially in real time), a price associated with transferring at least one of the set of electronic media files from the central media exchange via the first front end. In yet another embodiment of the invention, the method further comprises allowing the media owner to change, in real time (or substantially in real time), a price associated with transferring at least one of the set of electronic media files from the central media exchange via the second front end.

In a further embodiment of the invention, the method also includes the steps of: (1) providing a second set of electronic media files at the central electronic media exchange, the second set of files being owned by a second media owner; (2) allowing a first retailer to sell transfers of one or more of the second set of electronic media files from the central media exchange via the first front end; (3) allowing a second retailer to sell transfers of one or more of the second set of electronic media files from the central media exchange via the second front end; (4) reporting, to the second media owner in real time, data indicating how many copies of each of the second set of electronic media files has been sold by the first retailer within a particular period of time; and (5) reporting, to the media owner in real time, data indicating how many copies of each of the second set of electronic media files has been sold by the second retailer within the particular period of time.

A method of distributing electronic media files according to yet another embodiment of the invention comprises the steps of: (1) providing, at a central electronic media exchange, a first copy of an electronic media file in a first format, and a second copy of the electronic media file in a second format; (2) selling a transfer of the first copy of the media file from the central electronic media exchange to a customer for a first price; (3) after selling the transfer of the first copy of the media file to the customer, receiving a request by the customer to receive a second copy of the electronic media file; (4) in response to receiving the request, confirming that the first customer purchased the first copy of the media file; and (5) in response to confirming that the customer has purchased the first copy of the media file, providing the second copy of the electronic media file to the customer. In a particular embodiment of the invention, the step of providing the second copy of the electronic media file to the customer comprises providing the second copy of the electronic media file to the customer for a price that is lower than the first price. In one embodiment of the invention, the step of providing the second copy of the electronic media file to the customer comprises providing the second copy of the electronic media file to the customer for substantially no additional consideration from the customer.

A method of distributing electronic media files according to yet another embodiment of the invention includes the steps of: (1) providing a first set of electronic media files at a central electronic media exchange, the first set of electronic media files being owned by a first media owner; (2) providing a second set of electronic media files at the central electronic media exchange, the second set of electronic media files being owned by a second media owner; and (3) allowing a retailer to bundle, for resale to customers: (a) a transfer, from the central electronic media exchange, of at least one of the first set of electronic media files; and (b) a transfer, from the central electronic media exchange, of at least one of the second set of electronic media files.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of an electronic content exchange system (and attached systems) according to one embodiment of the invention.

FIG. 2 is a flow diagram for an electronic content exchange system according to a particular embodiment of the invention.

FIG. 3 illustrates the logical architecture of various electronic content exchange services according to one embodiment of the invention.

FIG. 4 illustrates a block diagram of an electronic content exchange system according to one embodiment of the invention.

FIG. 5 demonstrates basic exchange services provided by an electronic content exchange system according to one embodiment of the invention.

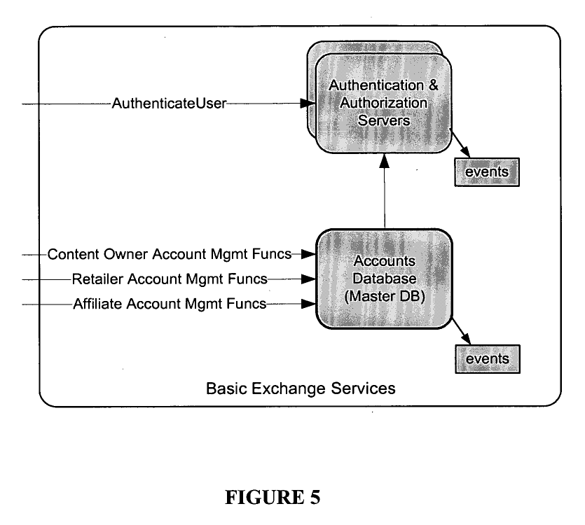

FIG. 6 illustrates exemplary federated catalog services provided by an electronic content exchange system according to one embodiment of the invention.

FIG. 7 illustrates exemplary retailer services provided by an electronic content exchange system according to a particular embodiment of the invention.

FIG. 8 illustrates exemplary content distribution services provided by an electronic content exchange system according to various embodiments of the invention.

FIG. 9 illustrates exemplary promotional affiliate services provided by an electronic content exchange system according to one embodiment of the invention.

FIG. 10 illustrates exemplary accounting back office services provided by an electronic content exchange system according to a particular embodiment of the invention.

FIG. 11 illustrates exemplary content publishing and listing flows in an electronic content exchange system according to one embodiment of the invention.

FIG. 12 illustrates exemplary content staging flows in an electronic content exchange system according to various embodiments of the invention.

FIG. 13 illustrates exemplary order processing flows in an electronic content exchange system according to particular embodiments of the invention.

FIG. 14 illustrates various exemplary electronic content exchange system systems and processes, as well as various content owner systems and processes according to various embodiments of the invention.

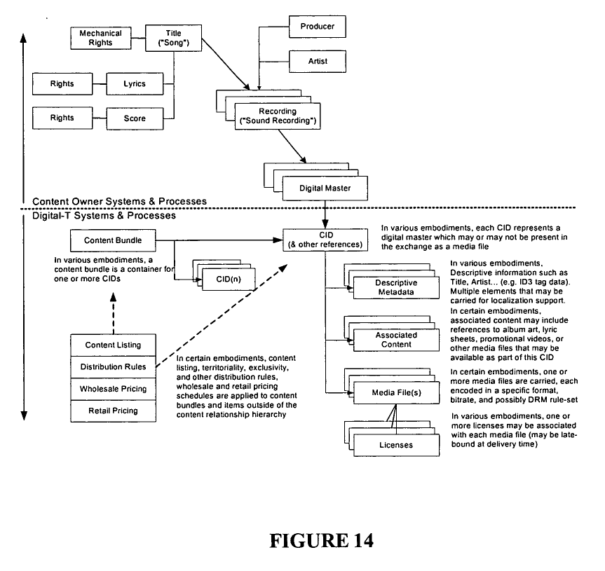

FIG. 15 illustrates an exemplary music industry domain model according to one embodiment of the invention.

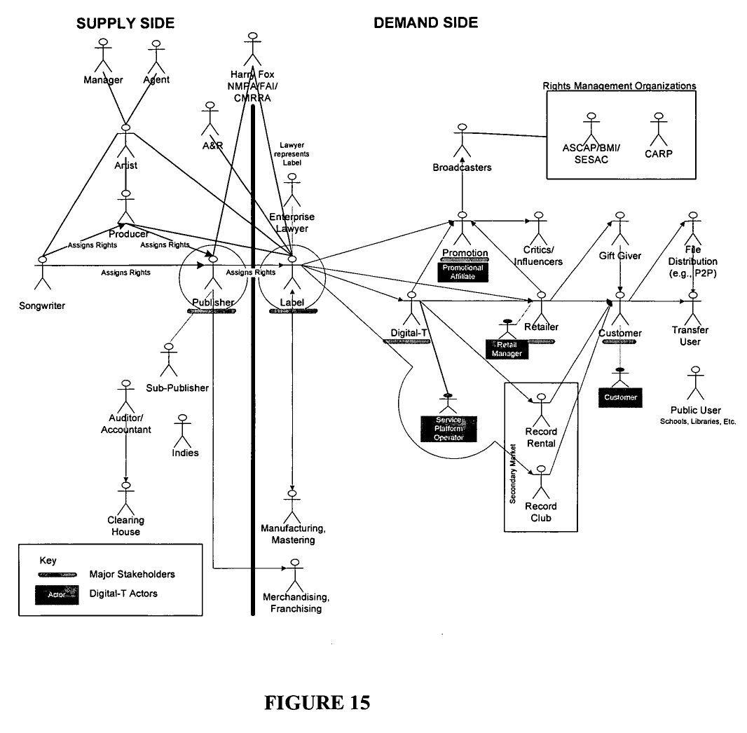

FIGS. 16A and 16B illustrate exemplary distribution and use scenarios supported by an electronic content exchange system according to various embodiments of the invention. These figures illustrate the iterative nature of various embodiments of the invention.

### DETAILED DESCRIPTION OF VARIOUS EMBODIMENTS OF THE INVENTION

The present invention now will be described more fully with reference to the accompanying drawings, in which some, but not all embodiments of the invention are shown. Indeed, this invention may be embodied in many different forms and should not be construed as limited to the embodiments set forth herein. Rather, these embodiments are provided so that this disclosure will satisfy applicable legal requirements. Like numbers refer to like elements throughout.

System Participants

A system according to a particular embodiment of the invention provides the services needed to support commercial interactions between: (1) one or more content owners; (2) one or more retailers, one or more end-users (e.g., listeners); (3) one or more promotional affiliates; (4) one or more service platform operators; and/or (5) one or more content reference services.

In various embodiments, content owners provide content (e.g., digital content such as digital music or video files) and may manage the rules for its distribution—wholesale prices, territory, etc. In various embodiments, content owners log into the exchange to manage content and prices, manage relationships with retailers, and run reports.

In certain embodiments, retailers operate online stores for the content owner's products. The retailer systems communicate electronically with the exchange to determine which items are available for sale, and for managing the online purchase of the content owner's products. In various embodiments, retailers log into the exchange to update their profiles and run reports.

In particular embodiments, end users (e.g., listeners) may purchase items through the retailers (e.g., through the retailers' web sites) and download those items from the exchange.

In various embodiments, affiliates may give away promotional items when authorized to do so by the relevant content owner. The affiliate may get paid to give away content, or may not. In either case, in certain embodiments, the affiliate interaction with the exchange is simpler than the retailer interface.

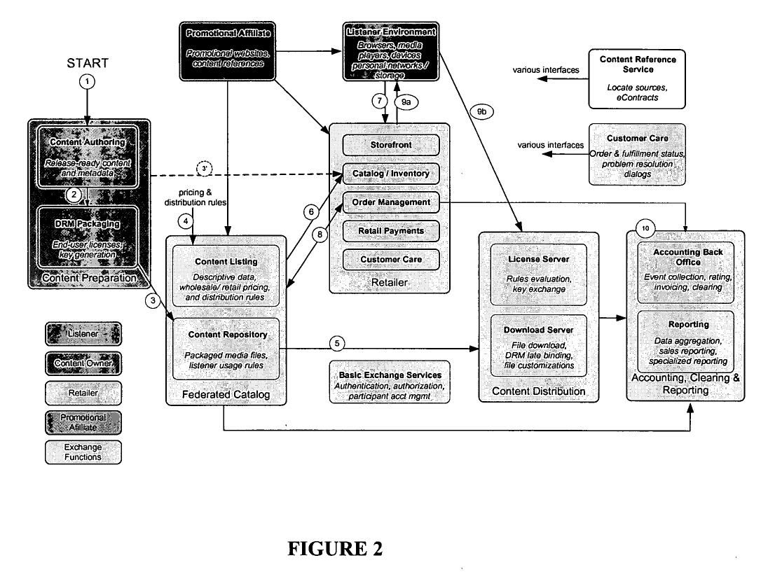

In particular embodiments, service platform operators operate one or more of the shaded systems shown in FIG. 2.

In various embodiments, a Content Owner (CO) authors and packages content, and manages the distribution rules, wholesale pricing, and suggested retail pricing for the content. In the system, a content owner may be, for example, an entity that owns the right to distribute the content.

Retailers may be, for example, online stores or other kinds consumer sales and distribution channels. In addition to traditional online retailers, the system supports the “communication service provider/retailer” where a communication service provider (such as a telecommunications carrier or an Internet Service Provider) offers digital works to their user base. In this model, the service provider may, for example, bill the listener according to the service provider's existing billing arrangement.

The design of systems according to various embodiments of the invention assumes that an end user's interaction with the system-based exchange almost entirely takes place through one or more retailers (e.g., retailer web sites). For example, if a listener wants to find content listings, the listener may do so through a retailer-based interface.

The system technology of various embodiments envisions a role for Promotional Affiliates, who function as promoters of particular content (e.g., an individual artist fan site), a particular provider (e.g., a record label), a class or genre of music, or a particular retailer. In certain embodiments, an affiliate is responsible for distribution of promotional content or other activities designed to drive retail sales or awareness. Affiliates may have, for example, some characteristics of end users, some characteristics of retailers, and/or some other unique characteristics.

In one embodiment, a service platform operator operates and manages one or more components of the electronic content exchange system. The system may be designed for interoperation of multiple ISPs operating similar or different parts of a total network, thus enhancing the federated nature of the service. In this embodiment, the service platform operator is responsible for operating some or all of the following components of the: (1) federated catalog component; (2) content distribution component; (3) accounting, clearing, and reporting components; (4) customer care components; and/or (5) basic exchange services.

In a particular embodiment, the system is designed to enable interoperability with the emerging standards for content reference, content identification, content description, and contract expression. While, in certain embodiments, the system does include content reference servers, in certain embodiments, it interoperates with these servers and thereby enables superdistribution and other business models.

Exemplary Services Offered by the System

A system according to a particular embodiment of the invention supports the following services. Implementations of a particular system infrastructure may incorporate some or all of these services.

Exemplary Federated Catalog Services:

Content Authoring and DRM Packaging: In certain embodiments, it is assumed that the content owner or an outside service is responsible for the authoring and DRM packaging of their content. Note that, in certain embodiments, DRM packaging is an optional step, assuming that the content is to be distributed in a DRM format.

Direct Provisioning with Retailers: In certain embodiments, content owners may establish or retain a direct connection to a given retailer's computer system.

Content Repository (Content Publication Services): In various embodiments, content owners place digital content and descriptive information on the exchange system for subsequent listing. Functions are provided for the registration of metadata and associated content, bundle creation, and ingestion of media files.

Content Listing: In various embodiments, content owners may list titles and bundles of content (e.g., albums) and their associated metadata, usage and distribution rules to the exchange for distribution and sale.

Catalog Search: In various embodiments, retailers, end users, promotional affiliates and other users may query the exchange for the availability and location of specific content.

Catalog Feed: In particular embodiments, a catalog feed interface propagates listing updates to support retail inventory management and other uses.

Notifications: In various embodiments, the federated catalog may support the ability to register for notifications on changes of content listing status.

Content Staging: In particular embodiments, the content repository may provide interfaces to stage content and license keys into the content distribution network.

Dealer Locator: A dealer locator according to one embodiment of the invention is configured to identify a retailer to provide one or more particular files specified by an end user, taking into account territoriality and exclusivity relationships between content owners and retailers.

Exemplary Retailer Services:

Order Management: The system may provide an order management interface which supports retailers creating, validating, and submitting orders for processing.

Customer Care: The System may provide support for Retailers' customer service operations, including order status, disputes and returns.

Exemplary End User Services:

Download Services: Managed download services may be provided to support downloading of paid and/or promotional content.

License Service: System may “wrap” DRM license servers to provide a unified interface to the end user environment.

Exemplary Promotional Affiliate Services:

Affiliate Registration: The system may support registration of promotional affiliates to enable various affiliate services.

Affiliate Promotional Functions: The system may provide support for downloading promotional content and marketing materials, creating various electronic referrals, and for registering and receiving content listing notifications.

Exemplary Accounting, Clearing, and Reporting Services:

Accounting/Financial Back Office: In certain embodiments, the system includes various accounting and financial back office features that provide functions for wholesale accounting including electronic record keeping, matching and aggregation, rating, invoicing, and billing detail generation. In addition, the system may provide support for refunds, adjustments, and other back-office processing.

Administration: Administrative functions may be provided for account management, system management, and the management of business rules.

Reporting and Statistics: In various embodiments, the exchange delivers reporting and statistics to track activity by title, retailer, listener, and/or other dimensions. The reporting and statistics functions may support both marketing information and business operations functions.

Exemplary Basic Exchange Services:

Authentication and Authorization: In various embodiments, the system is configured to provide authentication and authorization services that allow users to log on to the exchange and use exchange functions.

Accounting Event Creation: In certain embodiments, the system is adapted to execute certain exchange functions to create account detail records, which are processed downstream by the system's accounting back office.

Service Management Functions: In various embodiments, the system provides simple interfaces for service management by ISP operators.

Exemplary Services Offered Outside of System

The following exemplary systems and services may be provided in conjunction with a system according to various embodiments of the invention.

Exemplary Content Owner Systems:

Content Authoring and DRM Packaging: In certain embodiments, it is assumed that a content owner or an outside service is responsible for the authoring and DRM packaging of their content. Note that, in certain embodiments, DRM packaging may be an optional step, assuming that the content is to be distributed in a DRM format.

Direct Provisioning with Retailers: In certain embodiments, content owners may establish or retain a direct connection to a given retailer's computer system.

Exemplary Retailer Systems:

Retail Online Storefront: In various embodiments, the system assumes that one or more particular retailers possess some kind of “Web Storefront” capability for displaying merchandise, taking orders, accepting payments, and handling disputes and refunds.

Non-Exchange Catalog and Order Functions: In certain embodiments, the system offers catalog and order management interfaces for handling content listed on the exchange system.

Retail Payments: In various embodiments, the retailer is responsible for providing their own retail payments and clearing. In such embodiments, the system may provide wholesale clearing for content purchased through the exchange.

Customer Accounts/Customer Service Back Office Systems: In various embodiments, the system offers customer care interfaces to determine order and fulfillment status for content purchased through the exchange. In certain embodiments, it is assumed that the retailer will provide customer account management and end-user customer care functions.

Exemplary Listener Environment:

Browser and Media Player: In certain embodiments, listener environments will have a variety of client solutions for browsing, media playback and organization, and other functions. In various embodiments, the system design makes no assumptions about client code other than standard browser functionality and some form of media player. While system listener functions may not require the presence of specialized end-user client code, opportunities exist to enhance the user experience by the provision of client code that takes advantage of the system's services.

Promotional Affiliates:

Promotional Affiliate Systems: In certain embodiments, the system design assumes that one or more particular promotional affiliates will have an affiliate site of its own designed using available web site design, deployment, and management tools. The services provided by the system to affiliates in various embodiments may be intended to connect affiliate sites to the exchange, and not to provide a complete “drop-in” affiliate solution.

Content Reference Servers:

The system may be designed to enable interoperability with the emerging standards for content reference, content identification, content description, and contract expression. While systems according to certain embodiments of the invention may not provide content reference servers, the systems may be configured to interoperate with these servers and thereby enable superdistribution and other business models.

Exemplary System Overview and Exemplary Purchase Process Flow

While the system can take many different forms, a retail purchase process flow according to one embodiment of the invention is as follows (See FIG. 2, in which the following steps are visually depicted by arrows that are numbered as indicated below):

1. Content items are authored and approved by content owners.

2. Content items are [in certain embodiments, optionally] wrapped with digital rights management encryption. In this simple DRM example, the content is encrypted at this stage and the DRM headers are included in the packaged file.

3. Content items are provisioned into the system's federated catalog content repository. The dashed line (3′) in FIG. 2 indicates that content may also be directly provisioned to retailers, bypassing the Digital-T system.

4. Wholesale pricing, MSRP, and distribution rules (e.g., territoriality and exclusivity) are set by the content owner, associated with content, and are keyed to specific retailers or classes of retailers. Any of the preceding may be associated with specific retailers, thus supporting complex distribution arrangements across a wide range of retailer participants. The content is also associated with a distribution staging scheme at this point.

5. Content items are staged into the content distribution network to various download server locations.

6. A listing feed is provided to retailers to enable inventory management as listings are added or changed.

7. An end user interacts with the retailer's web storefront. Access to the system's search functions by listeners may be provided through the retailer (e.g., through a web site associated with the retailer), and results are filtered based on a pricing and distribution set for that retailer.

8. The retailer uses the order management interface to assemble, validate, and place an order with the system.

9. The order is completed by returning fulfillment details to the listener, who manually or via client code downloads media files and licenses.

10. Accounting events are generated throughout, and are forwarded to the accounting back office for audit, clearing, settlement, and reporting.

According to one embodiment of the invention, the high level flows illustrated in FIG. 2 are provided by the underlying services offered by the following service groups: (1) basic exchange services; (2) federated catalog services; (3) retailer services; (4) content distribution services; (5) promotional affiliate services; and (6) accounting, clearing and reporting services. These various service groups are discussed below.

Basic Exchange Services

In one embodiment of the invention, the Digital-T system uses a role-based capabilities model for system authentication and authorization. In this embodiment, system interfaces may require proper credentials for access to services and for use of functions.

As a precursor step to most exchange operations, users authenticate to the exchange and receive session, capabilities, and profile objects, and an accounting event is created.

| Basic | | |
|---|---|---|
| Exchange services | Purpose | Notes |
| Authentication and | | |
| Authorization | | |
| AuthenticateUser | Provide authentication | Content provider uses |
| | and role based | AuthenticateUser to request |
| | authorization for | exchange access for listing |
| | exchange actors | content |

| | |
|---|---|
| Account | |
| Management | |
| CreateCOAcct | Create a new content owner account |
| DeleteCOAcct | Delete a content owner account |
| GetCOAcctProfile | Fetch the profile information for a content |
| | owner account |
| SetCOAcctProfile | Set the profile information for a content owner |
| | account |
| GetCOAcctStatus | Fetch the status information for a content |
| | owner account |
| SetCOAcctStatus | Set the status information for a content |
| | owner account |
| CreateRTAcct | Create a new retailer account |
| DeleteRTAcct | Delete a retailer account |
| GetRTAcctProfile | Fetch the profile information for a retailer account |
| SetRTAcctProfile | Set the profile information for a retailer account |
| GetRTAcctStatus | Fetch the status information for a retailer account |
| SetRTAcctStatus | Set the status information for a retailer account |
| CreateAFAcct | Create a new affiliate account |
| DeleteAFAcct | Delete an affiliate account |
| GetAFAcctProfile | Fetch the profile information for an affiliate account |
| SetAFAcctProfile | Set the profile information for an affiliate account |
| GetAFAcctStatus | Fetch the status information for an affiliate account |
| SetAFAcctStatus | Set the status information for an affiliate account |

Federated Catalog Services

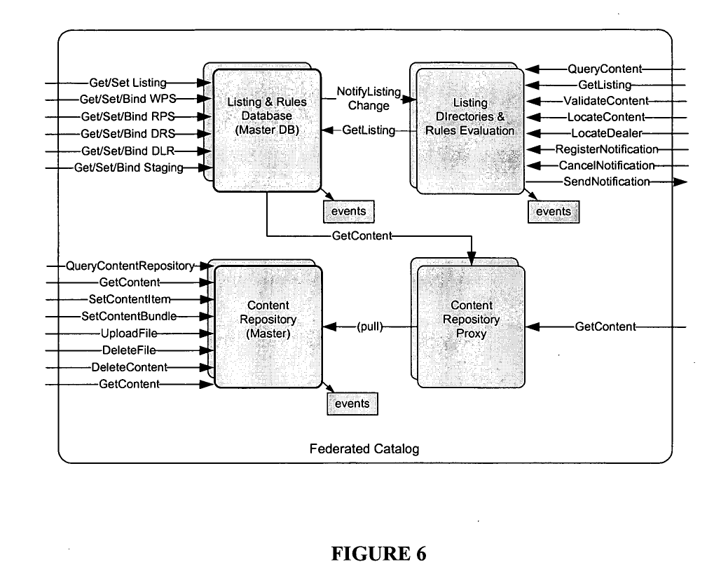

As shown in FIG. 6 and in the table below, one embodiment of the Digital-T system implements federated catalog functions using the following services.

| Federated Catalog | | |
|---|---|---|
| Services | Purpose | Notes |
| Publication Services | | |
| QueryContentRepository | Returns one or more Content Items | |
| | and/or Content Bundles. | |
| GetContent | Retrieves a single content item or | |
| | bundle from the local repository | |
| SetContentItem | Create a new Content Item | |
| | document in the repository or | |
| | update and supersede an existing | |
| | Content Item document | |
| SetContentBundle | Creates a new Content Bundle | |
| | document in the repository or | |
| | update and supersede an existing | |
| | Content Bundle document | |
| UploadFile | Makes a file available in the | |
| | repository and establish or replace a | |
| | file handle (FileGUID) | |
| DeleteContent | Delete a Content Item or Content | |
| | Bundle from the repository | |
| DeleteFile | Delete a file (FileGUID) from the | |
| | repository | |
| Listing Services | | |
| Get/Set/Listing | Read and update listings | |
| Get/Set/BindWPS | Wholesale Price Schedule (WPS) | |
| | mgmt | |
| Get/Set/BindRPS | Retail Price Schedule (RPS) mgmt | |
| Get/Set/BindDRS | Distribution Rule Set (DRS) mgmt | |
| Get/Set/BindDLR | Download Rules set (DLR) mgmt | |
| Get/Set/BindStaging | System functions for staged content | In most embodiments, |
| | mgmt | staging functions are not |
| | | accessible to content owners, |
| | | but to the service platform |
| | | operators. Staging |
| | | instructions may be bound |
| | | automatically to listings. |
| NotifyListingChange | Notify registered group of a listing | |
| | change | |
| Content Directory | | |
| Services | | |
| QueryContent | Returns information regarding one | |
| | or more Content Items and/or | |
| | Content Bundles. | |
| GetListing | Returns listing information that has | Used to simplify automatic |
| | changed since the last call to | refresh of exchange |
| | GetListing. | information. |
| ValidateContent | Validate the availability and offer | |
| | terms of a list of content items | |
| LocateContent | Return download and license server | |
| | locations for a list of content items | |
| LocateDealer | Return a list of retailers which may | |
| | offer the specified content | |
| RegisterNotification | Register to receive email or other | A listener may register for |
| | form of notification when a | notification when the next |
| | triggering event occurs | song by an artist is released |
| | | on the exchange |
| CancelNotification | Cancel an existing registration | |
| SendNotification | Send a notification when a trigger | New content is listed for the |
| | event occurs. | artist in the previous |
| | | registration |

Retailer Services

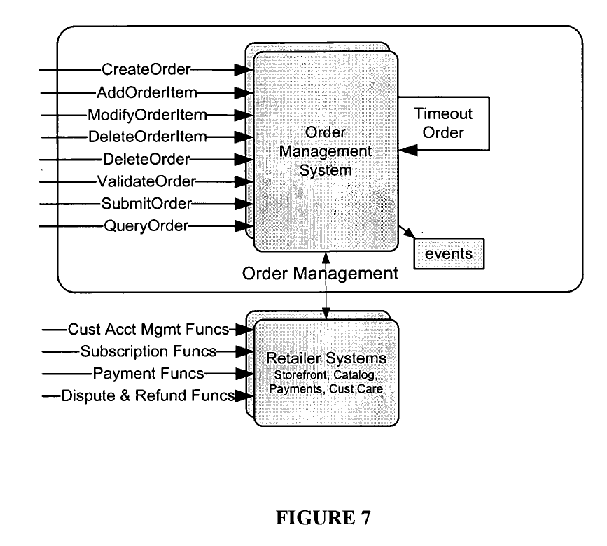

As shown in FIG. 7 and in the table below, one embodiment of the Digital-T system supports retail order management functions using the following services.

| Function | Purpose | Notes |
|---|---|---|
| Retailer Services | | |
| Order Management | | |
| Services | | |
| CreateOrder | Create a new order and [optionally] | |
| | add an initial item | |
| AddOrderItem | Add an item to order | |
| ModifyOrderItem | Modify order item quantity | |
| DeleteOrderItem | Remove item from order | |
| DeleteOrder | Remove order from the system | |
| ValidateOrder | Validate order parameters, pricing, | |
| | and content availability, locate | |
| | download sources | |
| SubmitOrder | Submit order for processing, return | |
| | fulfillment list | |
| QueryOrder | Query order details, current state, | |
| | and fulfillment status | |
| TimeoutOrder | Remove unsubmitted order from | This is a system-initiated |
| | the system | action to clean up abandoned |
| | | orders |
| Retailer Supporting | | These systems are closely |
| Services | | bound to the order |
| | | management functions |
| Customer Account | Used to manage order/download- | Optional function assumed to |
| Management Functions | time listener preferences and | be provided by non-Digital-T |
| | settings | retailer systems (external |
| | | system) |
| Subscription Functions | Used to match orders with | |
| | subscription terms | |
| Payment Functions | Used to pay for orders | |
| Dispute & Refund | Used to manage additional | |
| Functions | downloads and license grants | |

Content Distribution Services

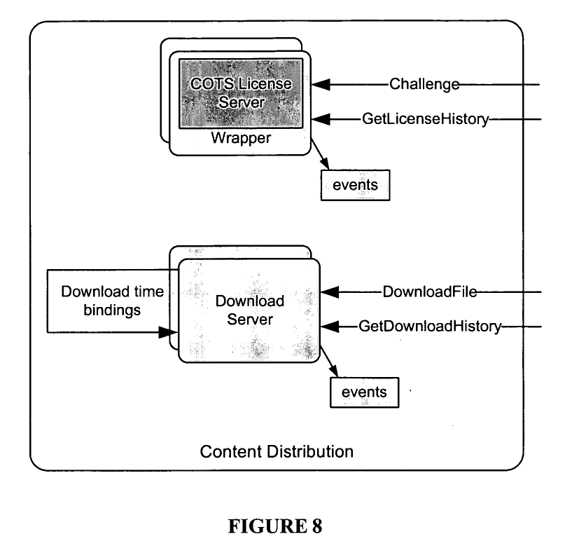

As shown in FIG. 8 and the table below, one embodiment of the Digital-T system supports content download and license serving using the following services.

Content distribution services employ download servers and commercial-off-the-shelf Digital Rights Management (DRM) license servers, wrapped by Digital-T transport and accounting.

| Function | |
|---|---|
| Content Distribution Services | Purpose |
| Challenge | Request license from server |
| GetLicenseHistory | Supporting function for customer care |
| DownloadFile | Execute the download of a content item |
| GetDownloadHistory | Supporting function for customer care |

Promotional Affiliate Services

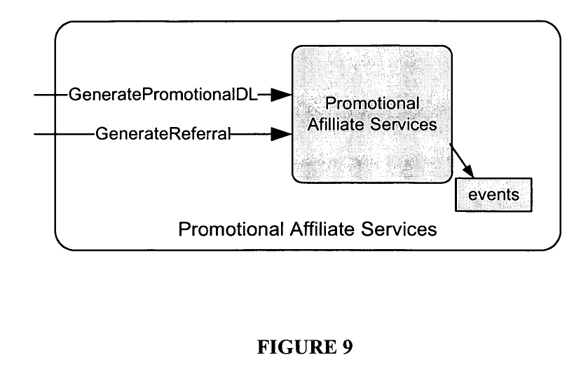

As shown in FIG. 9 and the table below, one embodiment of the Digital-T system supports promotional affiliates using the following services.

| Function | | |
|---|---|---|
| Affiliate Services | Purpose | Notes |
| Affiliate Account Management | Affiliate registration and account | See Basic Exchange |
| | maintenance | services |
| GeneratePromotionalDownload | Produce a download token for | |
| | promotional content | |
| GenerateReference | Generate a reference for a piece | Typically tied to a given |
| | of content | retailer or content owner |

Accounting, Clearing and Reporting Services

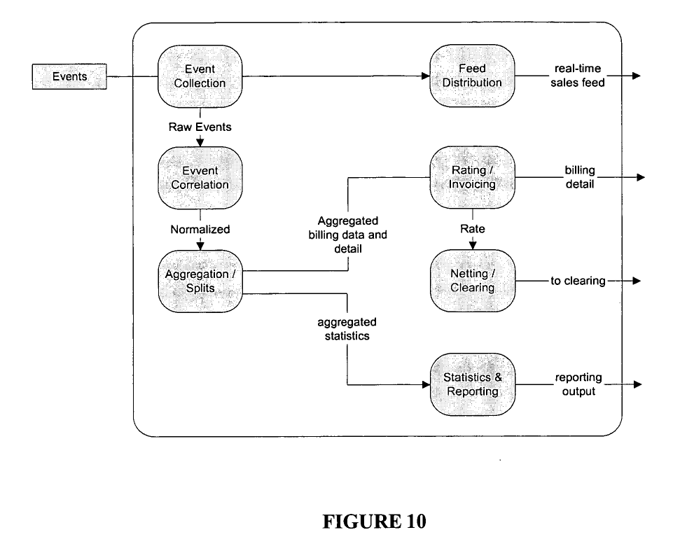

As shown in FIG. 10 and the table below, one embodiment of the Digital-T system provides accounting back office functions for settlement, clearing, and reporting using the following services.

| Function | |
|---|---|
| Accounting Back Office | Purpose |
| Event Collection | Collect raw exchange events |
| Event Correlation | Match and correlate related events |
| Aggregation/Splits | Organize billing items into accounts |
| Rating/Invoicing | Apply rate information and |
| | generate invoices |
| Netting/Clearing | Clear open balances, collect funds, |
| | net out |
| Statistics & Reporting | Create sales and usage reporting, |
| | output aggregated and raw data for |
| | downstream reporting and analysis |
| | systems. |

Special Concepts

The following concepts relate to a system exchange according to a particular embodiment of the invention.

Digital Rights Management Interoperability and Neutrality: In various embodiments, the system is designed to accommodate various different Digital Rights Management (DRM) methods, systems, and formats. Further, in certain embodiments, through the concept of Content Equivalence, the system supports distribution in multiple codecs and DRM formats, as well as management of rules permitting the use of multiple codecs and formats by a given listener. In certain embodiments, the system accommodates DRM in one or more of the following ways:

(1) Provides rich metadata for carrying copyright, terms of use, and other rights information.

(2) Support for download and use terms that span multiple, packaged DRM licenses for a given listener.

(3) Multiple format support permits carrying titles using multiple, different DRM wrappers, formats, and license terms.

(4) Extensible metadata can carry XrML or other DRM license terms should DRM application be necessary during download time (e.g., support for late binding).

Support for Territoriality and Exclusivity: In certain embodiments, the system is configured to provide support for the related concepts of territoriality and exclusivity in order to enable support of existing content distribution channels and agreements, as well as to construct new distribution agreements based on network as well as geographic territoriality. In particular embodiments, the system supports the following:

(1) Associating a listener with a retailer (e.g., referring the listener to a particular retailer's web site) based on the listener's geographic attributes (billing address), network information associated with an end user (e.g., the end user's network address) (Source IP) or current location.

(2) Locale, distribution relationships, and listener service provider relationships may be taken into account in recommending one or more retailers for a end user.

(3) An end user's search results may be filtered depending on which retailer launched the query. This may serve to enforce exclusivity and other distribution-specific presentation—e.g., content that is not available to a particular retailer will not be returned in the searches initiated from that store.

(4) A given retailer's order validation and submissions may observe exclusivity in order to prevent purchase of content that is not legitimately available through that retail channel.

(5) Listeners may be directed to download resources based on their network and/or physical geography.

Locate Dealer: In one embodiment of the invention, the Digital-T system provides a special-purpose query function used mainly by consumers to find out a “nearby” dealer given a content reference and/or consumer location information. “Nearby” may mean, for example, that the dealer is associated with the network “location” of the customer, or that the dealer is geographically close to the customer. The specialized query function may return a list of retailers that can service a sale of the content listed in the results of a particular customer's search. Territoriality and exclusivity may be taken into account in the response set.

An exemplary Dealer Locator can use Zip code, area code, ISP, source IP, email domain, referring URL, and/or, if present, source coding from the exchange referring URL and exchange-based customer account info to help make a choice. Some subset of this information is passed in the request, along with the title identifying information.

Dealer Locator functionality may depend, for example, on the platform on which the Dealer Locator is invoked. A few exemplary use cases are listed below:

### EXAMPLE 1

A Dealer Locator invoked from a particular affiliate's web site searches for retailers who are on the affiliate's list of retailers and that are related to the customer, either as the customer's ISP or geographically.

### EXAMPLE 2

A Dealer Locator invoked from an ISP portal page automatically indicates the ISP as an appropriate retailer (if the ISP is a retailer), or else a list of retailers that are identified at least in part based on their geographical relationship with the end user conducting the search.

### EXAMPLE 3

A Dealer Locator invoked from an exchange home page (e.g., LyriCity) invites the end user (e.g., customer) to fill out a profile of geographic and network information and then recommends an appropriate retailer based, at least in part, on this profile.

Content Source Coding: In various embodiments, the system is configured to associate a globally unique ID with a particular download and mark the download with that ID. This serves to identify the download and to tie it back to the Content Identifier (CID) and any parent CIDs.

ID3 Tag or Other Plain Text Markers—In one embodiment of the invention, the Digital-T system provides unique identifiers in the ID3 Tag (or other plain text user modifiable format) certain unique identification of the content relative to the exchange.

Identifier in a secure portion of the file—In one embodiment of the invention, assuming a Digital Rights Management (DRM) scenario, each file has a signed header. If the Digital-T system places a unique value in each header (and then signs the header) immediately prior to downloading the media file, it has effectively serialized the file.

Digital Watermark or Steganographic marking (aka Forensic Masking)—In one embodiment of the invention, Digital Watermarking technologies allows the exchange to embed a digital code into the media file. The code may be imperceptible during normal use but is readable by software.

Notifications: In certain embodiments, the system provides notifications of additions or changes to content listings. Notifications may use a “publish and subscribe” approach to inform exchange actors of the occurrence of exchange events such as new or changed listings and pricing changes. These notifications are typically intended for human exchange participants; attached systems may have a different mechanism for synchronizing with exchange events.

Dynamic Pricing: In various embodiments, a system based exchange allows content owners to change wholesale and Manufacturer Suggested Retail Price (MSRP) schedules without restriction. This is a useful feature for, e.g., wholesale promotions, markdowns after a big concert, and/or “liquidating inventory”. In certain embodiments, dynamic pricing may require the exchange to keep track of the price at which a title was ordered/fulfilled, and record a purchase of the content at that price rather than the market price at the time of fulfillment.

In one embodiment of the invention, the Digital-T system allows for dynamic pricing, which is the ability for the system to automatically re-price content based upon algorithms provided by (or approved by) the content owner or another individual. For example, the system may be adapted to automatically discount content that is not selling well, and/or to automatically raise the price of popular content.

In various embodiments, the Digital-T system achieves dynamic pricing by changing the pricing tier to which the content is assigned. The decision as to whether to change the pricing tier with which a digital item is associated may be based, for example, upon the performance of that item when compared to other items on the exchange. The Digital-T system may support several algorithms. Exemplary input parameters for the algorithms include the following data items: (1) current tier; (2) number of units sold in preceding period; (3) length of time that the digital file or bundle (e.g., music track/album) has been on the Digital-T System; (4) length of time that the digital file or bundle (e.g., music track/album) has been at the current tier; (5) unit sales threshold value(s); (6) unit sales period(s); (7) whether to dynamically price up; and (8) whether to dynamically price down.

In various embodiments, an accounting record is generated whenever the re-pricing algorithm is run on behalf of a Content Owner. An accounting record is also generated for each piece of content that is automatically re-priced. A log is recorded of all content that was configured for dynamic pricing but could not be re-priced due to insufficient listener terms at the new tier.

Private Labeling/Shared Services: In certain embodiments, the system supports private labeling and shared services operations at both the content owner and retailer levels. Operations may be configured to support multiple provider access and personalization at multiple levels, including, for example:

(1) Presentation through attached systems (e.g., content authoring and packaging systems, retailer storefront, etc.)

(2) Access to exchange functions via proxies controlled by end-actors (e.g., QueryContent via retailer);

(3) Filtration of result sets based on point-of-origin; and

(4) System distribution designed to co-locate critical systems with volume users.

Internationalization and Localization: In various embodiments, the system may be configured to serve music and related content in multiple languages and geographies (locations). To this end, the system may be configured to provide a fully internationalized platform for carrying content, descriptive metadata, pricing, and marketing data in multiple languages. The following mechanisms may be used to support internationalization and localization: (1) user content language settings; (2) support for 16 bit character sets; (3) multiple metadata blocks for carrying multiple language metadata content descriptors; and (4) multiple currency specification and display (e.g., at the retail level).

Distributed Trust Model: In various embodiments, the system assumes that many different participants will be providing services throughout the value chain. In certain embodiments, Digital-T provides verifiable, and—where necessary—cryptographically secure processes for content distribution, event and settlement accounting, and audits.

Interfaces to Attached Systems

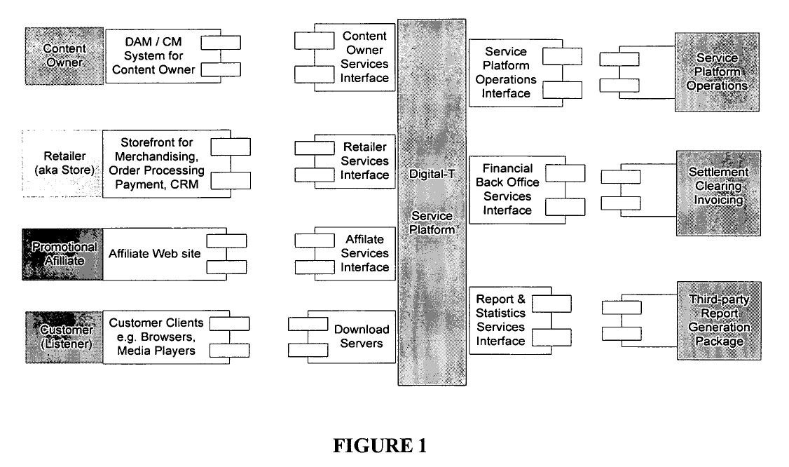

FIG. 1 illustrates an exemplary overview of the Digital-T Exchange and systems associated with the Digital-T exchange. In various embodiments of the invention, the Digital-T system exchange is designed to provide a set of services that are wrapped by a set of attached systems. Various embodiments of the invention therefore permit different implementations to support content owners, retailers, and supports integration with multiple back office solutions. An exemplary set of services and systems according to various embodiments of the invention is described below:

Content Owner Attached Systems: In one embodiment of the invention, the Digital-T system enables content owners to prepare content for listing on the Digital-T exchange, and then publish and list the content. In various embodiments, the working assumption is that there will be a content management system in place, one which will be able to bundle together: (1) Content (which can itself be complex, e.g., an audio recording, plus album art, plus a lyric sheet, etc.); (2) Metadata; and/or (3) Rights Information. In one embodiment, the bundle will include an XML-based structure organizing the various pieces. The content owner needs to be able to generate this structure for publication and deliver the structure for listing on a Digital-T-based exchange. The structure is discussed in the document titled “Critical Data Structures”.

Retailer Attached Systems: In one embodiment of the Digital-T system, a retailer possesses some kind of “Web Storefront” capability for displaying merchandise, taking orders, accepting payments, and handling disputes and refunds. The Digital-T system may be configured to connect these capabilities from the retailer store to the Digital-T exchange.

In various embodiments, there are two “tightly bound” retailer systems shown in FIG. 2 and linked into retailer processing: (1) Customer Accounts/Customer Service Back Office system; and (2) Payment Processing and Gateway system.

Promotional Affiliate Attached Systems: In one embodiment of the Digital-T system, one or more promotional affiliates have an affiliate website of their own. The services provided by the Digital-T system to affiliates may serve to connect affiliate sites to the exchange.

Customer Attached Systems: In various embodiments of the invention, the end-user (consumer) will be using a customer computer running one or more of various client solutions for browsing, media playback and organization, and other functions. In various embodiments, the Digital-T system makes no assumptions about client code other than standard browser functionality and the assumption of some form of media player. While Digital-T customer functions may not require the presence of specialized end-user client code, exchange functionalities can enhance the user experience by the provision of client code that takes advantage of various aspects of the Digital-T system.

Service Platform Operator Attached Systems: In various embodiments of the invention, there are simple “access points” for web based (or other) presentation of basic operations such as account management and system maintenance functions.

Back Office Attached Systems: In various embodiments of the invention, the Digital-T system provides for a defined interface between the back office exchange functions, so that an outsourced back office that conforms to the “Account Services” interface can be substituted for an in-house implementation.

Reporting/Statistics Attached Systems: In one embodiment of the invention, the Digital-T system uses the COTS package for generating reports. However, any other suitable reporting package may be used.

Selected System Interactions

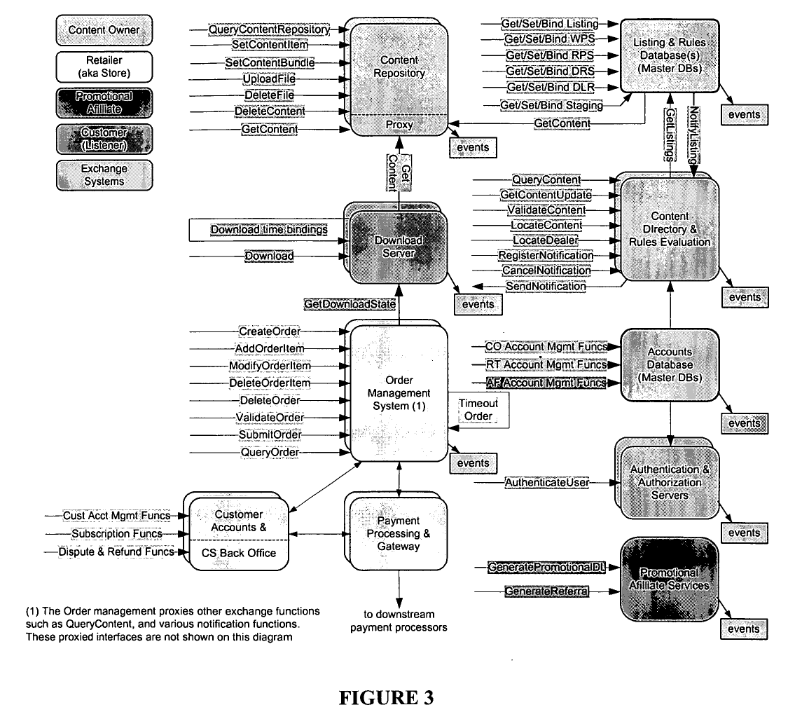

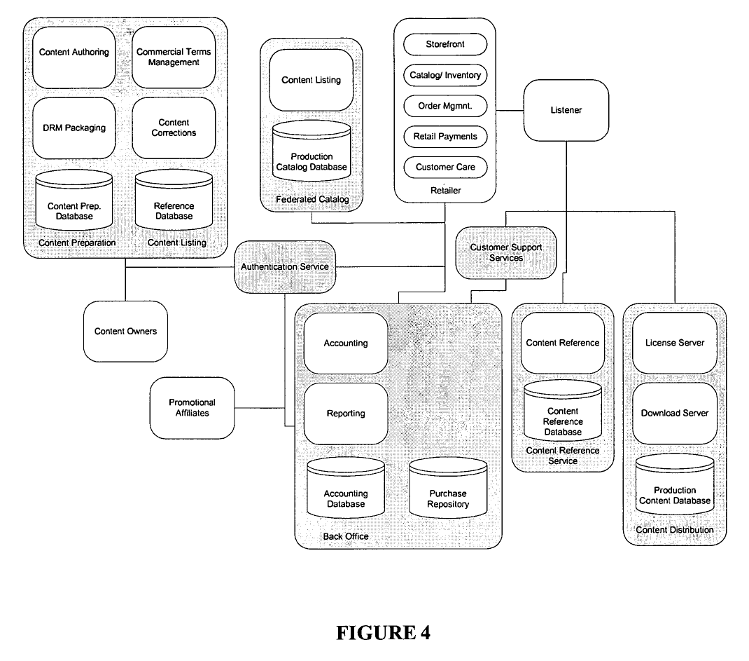

FIG. 3 illustrates an exemplary overview of the Digital-T services mapped to logical units. In various embodiments of the invention, the Digital-T system enables simple execution of various functions on local systems, with minimal interaction with other systems in the exchange. Various interactions that cross sub-system boundaries within the Digital-T system are described in this section. This section references FIGS. 3, 4, 11, 12, and 13 in describing the interactions among the various components of the Digital-T system and data stores for selective processes. Introductory comments to support the diagrams, as appropriate, are listed in the table, below.

| Interaction | Description/Comments |
|---|---|
| Publish and List Content | Publishing and listing content is a multi-step process which involves |
| | first publishing the content into the system, then creating a listing for |
| | that content. |
| Content Staging | In various embodiments, content staging is a component of download |
| | functionality and is described separately. |
| Order Processing | Order processing involves communications with various parts of the |
| | exchange and with attached systems. |
| Download (Order | Download functions have been optimized to support massive scaling |
| Fulfillment) | with commodity hardware and software, and to require minimal |
| | communication with other parts of the exchange. These functions are |
| | described in the following sections. |
| Promotion Support | Many tools and design points across the exchange support promotions. |

Content Provisioning: Publish and List Content

In certain embodiments, publishing and listing content involves ingesting the content and its description, then creating and propagating a listing record for that content. In various embodiments, content provisioning is a two-step process including Publication and Listing. In certain embodiments, publication entails making content, metadata, and other related data available to the exchange for further operations.

In particular embodiments, listing includes binding pricing and distribution rules to published content for transacting on the exchange. These steps may be performed individually or as bulk operations.

In certain embodiments, a completed listing includes a Content Listing Structure containing one or more (and typically all) of the following elements:
(1) A Content Item including: (a) an identifying CID (and other, optional, alternate identifying information); (b) one or more descriptive metadata structures; (c) one or more associated content structures (e.g., marketing images); and/or (d) one or more media files representing that content in differing formats/DRM wrappers.
(2) Distribution control structures including: (a) one or more wholesale pricing schedules keyed to retailers; (b) one or more retail pricing schedules keyed to retailers; (c) one or more sets of distribution rules keyed to retailers; (d) one or more sets of download rules keyed to retailers; and (e) one or more sets of staging configuration records.

In certain embodiments, publishing content involves selecting content to be delivered which, depending on the level of integration between the exchange and the content owner's authoring and DRM packaging systems, may take the form of “exporting” content from these systems or may take the form of a “select content to provision” dialog provided by content owner's systems. In either case, one or more XML documents are typically forwarded to the exchange.

In certain embodiments, when content has been selected, the exchange: (1) validates the content for syntactic and semantic correctness; (2) creates a content repository entry, and/or (3) stores the content repository entry in the repository.

In various embodiments, updating content involves retrieving an existing content repository entry (using QueryContent), and revising its metadata either interactively or by selecting content as in “publishing” above and approving the replacement of the existing content repository entry with the new one. In either case, the modified content repository entry is stored in a repository, provided the following operations succeed:

(1) In various embodiments, if the content being updated has already been listed, a check against the Content Directory occurs to ensure that the updated content does not violate any listing or distribution rules. In certain embodiments, the Content Directory is then updated.

(2) If the content being updated has already been staged to download servers, the new content is re-staged as a consequence of updating the Content Directory.

Interfaces: In various embodiments, the system is configured to offer content publication services at an interface level. In certain embodiments, an authoring, DRM packaging, and/or other content management system will be provided or interfaced to perform the end-user editing and management functions.

In various embodiments, content listing and delisting is performed by content owners to make content available on the exchange and to set the pricing and distribution rules for content. In certain embodiments, listing a title associates a published content item or content bundle with one or more wholesale price schedules, retail price schedules (MSRP), and/or one or more sets of distribution rules that apply to specific distribution contracts. In various embodiments, once content is listed, a title is ready to be downloaded and staged to one or more download servers.

Relationships Between Listings, Content, Pricing Schedules, and Distribution Rules

In certain embodiments, a listing represents one content item or bundle, designated by a CID (which can be versioned). In various embodiments, Wholesale Pricing Schedules (WPS) provide a mechanism for defining dealer-specific wholesale pricing. In a particular embodiment: (1) A WPS defines the unit and volume pricing for a title (e.g., a particular digital file); (2) Each listing binds one or more WPS; (3) A WPS may be bound to multiple listings; (4) A WPS bound to a listing is keyed to one or more retailers or classes of retailers; (5) Retail Pricing Schedules (RPS) provide a mechanism for setting suggested retail pricing within territories.

In a particular embodiment: (1) An RPS defines the suggested retail price of a title and other retail attributes; (2) Each listing binds one or more RPS; (3) An RPS may be bound to multiple listings; and/or (4) an RPS bound to a listing is keyed to one or more retailers or classes of retailers.

In various embodiments, Distribution Rule Sets (DRS) provide a mechanism for managing exclusivity and other distribution relationships. In a particular embodiment: (1) A DRS defines how (if at all) the system should restrict distribution of a title; (2) each listing binds one or more DRS; (3) a DRS may be bound to multiple listings; and/or (4) a DRS bound to a listing is keyed to one or more retailers or classes of retailers.

In certain embodiments, Download Rule Sets (DLR) provide a mechanism for controlling download behavior for a particular electronic file. In a particular embodiment, a DLR defines: (1) how many times a title can be downloaded (“5 downloads are permitted”); (2) date or time limits on download (“between start and end”, “In the next 10 days”); and (3) the absolute number of times a title can be downloaded (“first 300 copies are free!”). Also, in particular embodiments, each listing binds one or more DLR, a DLR may be bound to multiple listings, and/or a DLR bound to a listing is keyed to one or more retailers or classes of retailers.

The user experience on the exchange may benefit from a uniform set of download rules. If a listener finds one download policy applying to one title and a different policy to a different title, the listener may be slower to trust the exchange downloading process, and may be reluctant to transact altogether. At a minimum, the download rule set for a given retailer would preferably be uniform.

This consideration may not apply to promotions, which, in various embodiments, may have their own download rules (“first 300 callers get a free download”) which listeners accept. The exchange may provide a default DLR (specifying the “standard download policies” for the exchange) which may be applied where not superseded.

Examples

Case A: For the title “Meringue Madness 2” (DRCDT1003) the content owner (Digicom Records) would like their standard retail and wholesale pricing to apply to all retailers. We assume Digicom has set up WPS_STD and RPS_STD to be the standard wholesale and retail pricing schedules for Digicom Records, and has keyed these schedules to the class of “All_Retailers”. We also assume their default “No_Restriction” DRS to be DRS_STD, also keyed to All_Retailers. The listing binds WPS_STD, RPS_STD, and DRS_STD to the title. Digicom does not specify a DLR for this title, so the exchange default rules (“60 days to download/5 attempts”) apply.

Case B: Due to the sudden popularity of Meringue, Digicom has cut a special volume discount deal with Amazon US, and has set up a new WPS for Amazon US, WPS_Amazon US. They bind this new schedule with the listing, keyed to Amazon US. From the effective date of the schedule, Amazon US will pay wholesale pricing and volume discounts set specifically for them.

Case C: The meteoric rise of Meringue has caused Amazon to offer sweetheart terms to Digicom, and to request exclusive distribution worldwide. Amazon also wishes to carry Meringue Madness 2 in the British (UK) and German (DE) stores and to set retail pricing separately. The following actions are taken:

(1) WPS_AmazonUK and WPS_AmazonDE are created, bound to the listing, and keyed to the UK and DE stores;

(2) RPS's are created for each territory (US, UK, DE), bound to the listing, and keyed to those stores;

(3) DRS's are established for each territory, bound to the listing, and keyed to those stores; and

(4) content is made unavailable to all other stores by creating and binding a “Not_Available” distribution rule, which is keyed to the class of “All_Retailers”.

Note: The wholesale volume pricing aggregation in this case may need to aggregate over the three stores.

Volume Based Wholesale Pricing

A retailer typically carries many items that all fall within the same wholesale pricing schedule. During accounting, all items associated with the same schedule may be aggregated and volume discounts may be applied to the entire aggregated set.

Exemplary Flows—Publish and List a Single Content Item

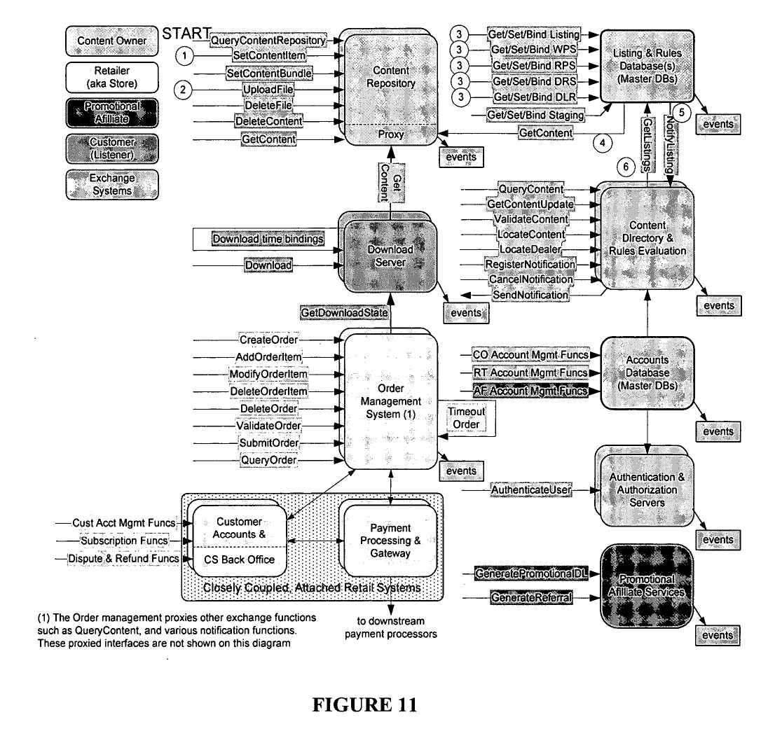

The following example, illustrated in FIG. 11, describes an exemplary publication and listing of a single content item. Publication of a content bundle may be handled similarly. Bulk operations may also use similar flows.

Content Publication and Listing Flows

(00) Precursor step: Content owners first connect to the exchange using the AuthenticateUser service to authenticate their session and receive authorizations to access the publication, listing, and other services.

(0) QueryContentRepository is an optional precursor step to publishing content. This function may be used by an attached authoring system to provide the base for revising a published content item.

(1) Publish a content item (XML description) into the content repository which provides service to that content owner.

(2) Upload related media file or files and bind to the content item. (Note: In various embodiments, Steps 1 and 2 can be intermixed, depending on how file bindings are handled—pre or post metadata publication).

(3) Create and edit the master listing and associated objects—wholesale pricing schedules, retail pricing schedules, distribution rules, and download rules. Bind these objects to the (still incomplete) listing record. (Note: Content staging configurations may also be automatically bound at this time. See discussion in following section.)

(4) Retrieve descriptive metadata from the content repository (or proxy) and bind to the listing to complete the listing.

(5) Notify the collection of content directory/rules evaluation systems that a new, completed listing is available. The notify listing function may actually serve as a “trigger” that causes the content directory to perform a GetListing operation which may, for example, retrieve one or more new listings.

(6) GetListing retrieves one or more listings from the listing and rules database by returning all new listings added since the previous pull. Once the listing is retrieved, it becomes available to the system when the system performs, for example, one or more of the following operations: (1) QueryContent; (2) GetListing; (3) ValidateContent; (4) LocateContent; (5) LocateDealer; and (6) Notifications.

Publication and Listing of Content Bundles

In various embodiments, publication and listing of content bundles is similar to content items, but the content descriptor document is more complex and may contain multiple levels of nested content. With the exclusion of adding the SetContentBundle operation, the remaining operations do not change.

Content Staging

In various embodiments, once content is published and listed it is staged to the download servers. For the purposes of this discussion, it should be understood that the term “download server” may refer to one or more download servers (including, for example, a cluster of download servers). A typical download server cluster is comprised of one or more download server units, a shared file system, and shared control mechanisms for performing content staging and for managing download rules.

Due to the size of media files, content may be pre-staged as opposed to relying on on-demand staging as is traditional in many content distribution networks such as CDNs designed for delivering web pages or other, smaller content files.

Configuration and Control

In various embodiments, the configuration and control of content staging is a service platform operator function that is provided as a service platform operator interface to the listing and rules database (e.g., as part of GetStaging, SetStaging, or BindStaging functions). In such embodiments, default staging configurations are defined for content owners that are then automatically bound to that CO's listings at listing publication time. Special titles (e.g., hits, promotions) and other titles that may require more broad based staging, can be handled manually by binding special staging configurations to specific listings.

Staging configurations are carried to the content directories as a part of the listing document, and are retrieved from the listings and rules database with other listing information using the GetListing interface.

Content Staging Flows

In certain embodiments of the invention, download servers (or clusters) are responsible for maintaining their own file inventory, according to the configurations bound to the listings. In this respect, download servers may act similarly to retailers using a store-managed catalog model, (See Retail Catalog Management, below), with the exception that the download servers may actually retrieve all files in addition to the content description documents.

The following steps describe an example that traces a download server from initial load through to ongoing staging operations, and discuss exception handling in case staged content is not present in the server.

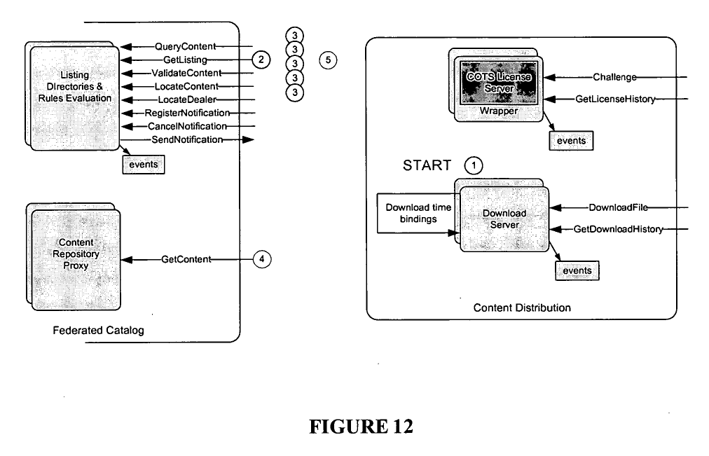

As shown in FIG. 12, the following steps are executed in an exemplary content staging flow:

(1) A download server is “brought up” with no content loaded.

(2) The server contacts the content directory in its configuration record using the GetListing function. The query contains the download server ID and a “zero” start date.

(3) The download server begins to build the inventory database by iterating the GetListing function until no further listings are returned.

(4) Concurrent to or following this operation, the download server contacts the content repositories (proxies) indicated in the returned download configuration records and uses the GetContent interface to retrieve the files to the local repositories.

(5) Following the initial catalog load, the download server periodically queries the content directory via GetListing for a list of adds, changes, and deletions (delistings), and resolves these similarly to the initial catalog load.

On-Demand Staging (Exceptions)

Depending on the size of the media file, the bandwidth between the download server and content proxy, the timeout of the user browser, and other factors, it is possible that on-demand staging may either succeed or fail. For example, a 5 MB file should download in less than 10 seconds over a 10 Mbps connection, accounting for protocol latencies and channel utilization inefficiencies. This is well within the typical 30-90 second browser timeout, but above many users' threshold of patience, which is about 8-10 seconds before a typical user will abandon a request.

In various embodiments, in the case where a file is requested for download that is not in the local repository, the download server performs the following steps to attempt to retrieve the content in time to serve the file to the download requestor, or at least to proactively stage the file into the repository should a re-attempt be made: (1) launch LocateContent to a content directory to determine the address of the content repository (proxy) serving this listing; (2) launch GetContent to the indicated proxy to fetch the content item document and the file; and (3) place the file in the local repository and serve the file to the download user. The file will then be available for subsequent downloads.

License Server Staging Operations

In certain embodiments, the Digital-T design supports the following models for DRM packaging and license serving:

(1) Pre-packaged content with common keys (and KeyIDs). Key generation and license servers share seeds distributed using a trusted PKI infrastructure. This method may require no per-file communication between the DRM packaging step and the license servers; and

(2) Dynamically-packaged content with individual file keys (and KeyIDs) being generated and “late-bound” during file download time. This may involve integrating DRM packaging functions with the download server. Similar PKI communications may be assumed for seeds.

Initial Catalog Load Optimizations

Initial catalog loads can be rather lengthy, depending on the number of titles, number of files per title, the size of the formats (e.g., PCM, SACD, DVD-A) and the bandwidth between systems. The system may be configured to provide room for load time optimization by ordering most popular titles first. If necessary, this may be performed by the result set filtering operations of the content directory.

Retail Catalog Management

A GetListing interface according to various embodiments of the invention is configured to help retailers manage the current inventory of exchange listings.

Three exemplary models that a retailer might use to manage the content catalog for their online store or service include an Exchange Managed Catalog or a Store Managed Catalog (or a hybrid of the two). An exemplary Exchange Managed Catalog Model and an exemplary Store Managed Catalog Model are described below.

Exchange Managed Catalog Model: In this model, a retailer does not create their own database of titles, but instead may rely on the QueryContent function to fetch listings as needed (e.g., as queries initiated by listeners). Sufficient merchandising information may be assumed to be present in the listings to enable retail presentation and to support selection by listeners.

Store Managed Catalog Model: In this model, a retailer keeps a database of titles, and updates or appends that database as listings change. While it is possible to manage a local catalog database using the QueryContent function, the more efficient GetListing function has been provided. In various embodiments, this interface permits the retailer to query all available listings (with the inclusion of optional query parameters) back to a particular date, and to receive the results as iterations. In certain embodiments, this function also supports keeping track of query parameters and update time so that subsequent queries will retrieve listing changes, additions, and deletions (delistings) since the time of the previous query (e.g., time-of-last-update). In various embodiments, the retailer has the option at any time to reset the last-update date by launching a new query should they wish a full catalog update.

Order Processing

In various embodiments, retail order processing involves creating a completed, fulfillable order, validating the order, collecting payment, and generating a fulfillment list that can be used by the listener to download content (or by client-side code to automate the download process).

Content Ordering

In certain embodiments, content ordering is performed via the retailer's online system in conjunction with Digital-T's order management services. An exemplary flow for a representative order is as follows:

(1) A listener finds a retailer (e.g., a web based retailer), either by referral from an affiliate, through an exchange-generated LocateDealer query, or by some other mechanism provided outside of the exchange.

(2) Listener browses the retailer store front (e.g., a retailer web site).

(3) When the listener selects content, the retailer creates a new order on the exchange and adds items to it. When the listener indicates that they wish to purchase the content, the retailer submits the order to the exchange for verification and checking via ValidateOrder.

(4) The exchange validates the syntax of the order and verifies basic rules, then locates content for all items in the order, if possible, and annotates the order list with either the locations of all items or a “NOT FOUND” location.

(5) If the returned, validated order is not complete (e.g., if there are some “NOT FOUND” items), the retailer may present this information to the listener for correction (e.g., “These titles were not found on the exchange; please find substitutes or remove them from your order”), or the retailer may invalidate the entire order (e.g., “Your order could not be filled at this time”).

(6) When the listener accepts a correct order, the retailer collects payment from the listener. If the payment operation is successful, the retailer requests a SubmitOrder of the order from the exchange. The exchange then produces an order fulfillment list with authorized downloads and/or licenses for each CID in the order and download locations. At the same time, the exchange produces accounting events for charging wholesale costs to the retailer.

(7) When the listener attempts to download the content on the fulfillment list, the exchange checks the attempt against download policies (e.g., only three attempts permitted) and notifies the listener if a download is not possible.

(8) If the download is permitted, the exchange finishes rendering the downloadable content, performs any other download-time modifications to the content (source coding, others), and downloads the content to the listener.

Example Flows—Order Content

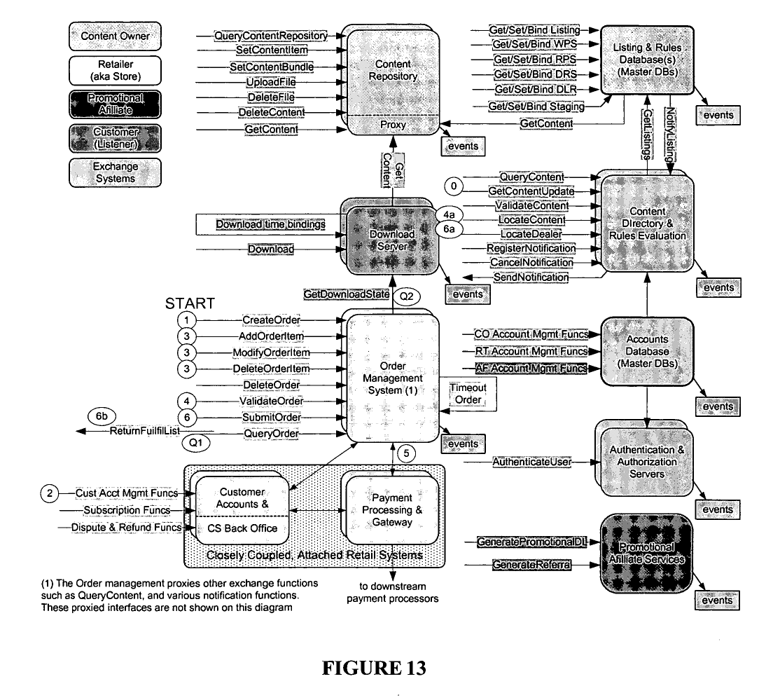

FIG. 13 depicts an exemplary order processing flow according to a particular embodiment of the invention. In particular, the exemplary order processing flow includes the following steps:

(0) QueryContent may be an optional precursor step to placing an order. A listener may have performed a query to locate the content they wish to purchase. The QueryContent function is proxied by the retailer for presentation to the listener (e.g., in certain embodiments, the listeners do not invoke the internal QueryContent interface directly).

(1) Create an order and add an initial item. This creates a unique OrderGUID and records the order in the exchange.

(2) The retailer may optionally access the listener's account for listener profile and preferences. This data may be useful to: (a) select listeners' preferred media format(s) (input to ValidateContent); (b) select download sites based on listener physical and network geography (input to LocateContent); and (c) create download customization instructions (e.g., ID3 tag customization in fulfillment list). User profile information may also be used by the merchant to compute special pricing or for other merchandising and promotions.

Note: If the listener identification and preferences are not known at CreateOrder time they may be added to the order prior to subsequent steps.

(3) Complete order by invoking zero or more: (a) item adds, (b) modifies and/or (c) deletes.

(4) Validate the order. This checks the order syntax and the availability of content to that retailer. Alternately, order validation may be invoked with each item added to the order. In certain embodiments, ValidateOrder performs the following actions: (a) invokes ValidateContent to validate content and format availability and to return wholesale and MSRP unit pricing available to that retailer for this sale. The listener's desired format(s) must be communicated at this time to determine the availability of the format(s)—this action may also return any special download rules (restrictions) placed on that title in order that the retailer may inform the listener prior to submitting the order; and (b) returns validated order or order with any annotations and/or failed line items.

(5) Collect payment. In certain embodiments, this function occurs outside of the order management system.

(6) Submit the order. This commits the wholesale transaction and returns fulfillment information for forwarding to the listener. In certain embodiments, the following steps are included as part of submitting an order: (a) invoke LocateContent for all items in the order. (The LocateContent module determines which download servers to route the listener to for fulfillment of each item, and may evaluate rules enabling multi-format or flexible format downloads—e.g., content equivalence relationships); and (b) create and return a fulfillment list including: (1) one or more sets of descriptive data for each item; and (2) one or more fulfillment URLs per item carrying one or more (and preferably all) of the following parameters: (1) download location; (2) order identification; (3) file identification; (4) valid time range (encoding of time within which URL is valid); (5) customization parameters; and (6) download signature—to authenticate and authorize download; and (7) Retailer URL to direct service inquiries.

Other Order Processing Operations

The following operations may also occur within the following sequence:

(1) DeleteOrder: A retailer may explicitly cancel an order.

(2) TimeoutOrder: The order management system may decide that the order is “stale” and delete the order. This function addresses issues regarding “abandoned shopping carts”.

(3) QueryOrder: At any time following CreateOrder, a QueryOrder may be invoked. This function operates queries on the OrderGUID or a limited set of indexed elements. It returns the full order(s) including the state of the order. If the order has previously been successfully submitted, the fulfillment list is also returned with the current download state indicated. This function may be useful, for example, for the following purposes: (a) order recovery—in the event the retail storefront system or communications failed; and (b) listener service—support manual or automatic listener inquiries regarding failed downloads, downloads remaining, content equivalence rules, or other fulfillment questions.

Other Considerations

User Preferences and Order Customization

In various embodiments, user preferences may be used for the following operations: (1) user physical or network geography—this may have bearing on the location of download sites; (2) use playback context and preferences such as preferred file format(s) and ID3 tag customization; and (3) any other suitable operations.

Fulfillment Lists

In various embodiments, the fulfillment list is designed to be presentable for end user “one URL per file” downloads, or as machine readable instructions to create single click package downloads at the server or client level.

Content Download

In certain embodiments of the invention, content download may occur once a fulfillment URL is provided to a listener or other user. [Note: The fulfillment URL may be the result of a purchase or a promotional download—in various embodiments, the download servers have no knowledge of upstream commercial processing.]

In certain embodiments, the fulfillment URL, as described in the preceding order processing section, contains one or more (and preferably all) of the following:
(1) Server Name: download server (or cluster), which may be represented, for example, by standard server.domain.tld structure;
(2) Order Identification: Identifies the order (OrderGUID) file is associated with. This field may also be used to identify a promotion or other non-sale initiated download;
(3) File Identification: Identifies the file to be downloaded by FileGUID;
(4) Valid Time Range: Encoding of the start and end times between which the URL is valid for download;
(5) Customization Parameters: Contains any parameters that must be passed to the download server for download-time bindings and customization. Examples include ID3 metadata tagging preferences, token for DRM rule set to use for late binding.
(6) Download Signature: This signature may be used by the download server to validate that the download request should be honored. In various embodiments, the download authorization is an MD5 hash of the following: (1) OrderGUID; (2) FileGUI; (3) ValidTimeRange; (4) Customization parameters; and (5) Signing Key—there are a number of options for this key ranging from a shared secret (e.g., 128 bit random number known to both the download server and the originator of the authorization), to a public key PKI implementation.

In one embodiment, on receipt of a fulfillment URL, the download server performs the following actions:

(1) Validates the server name—if this check fails, the server returns a suitable error message, as would all failures listed below.

(2) Validates the URL parameters by checking the download signature.

(3) Validates the time range.

(4) Checks the download server counter for this download request. Download counters may be kept for each OrderGUID, FileGUID. The counter is local to the server (or server cluster) and is hit once for each download request. The operation is one of: (a) read and increment the counter (if counter exists); and (b) create and increment from zero, stamp counter with valid end-date (if counter does not exist).

(5) If all tests pass, the file (FileGUID) is fetched from the local file system. Due to the size of media files, in various embodiments, content is pre-staged (see previous discussion on Content Staging). In various embodiments, if, for some reason, staging has not occurred, the content is staged on-demand once a cache failure is detected. Depending on the size of the media file, the bandwidth between the download server and content proxy, the timeout of the user browser, and/or other factors, it is possible that this on-demand staged download will fail. The on-demand staging action may serve to initiate the staging process so that subsequent requests will not experience the same problems.

(6) The file may require file customization or late binding steps to occur. Exemplary possible file customizations include: (a) File source coding such as ID3 tag or other plaintext, user modifiable format, digital watermark, or file append; (b) ID3 tag customization; and (c) DRM bindings.

(7) The file is delivered to the listener. At this point, the listener may play the file directly, or the listener's media player may require a callout to a license server in the media file header.

In alternate embodiments of the invention, the system is adapted to deliver the key concurrently with the file download for inclusion in the user's license cache.

Accounting/Financial Back Office

FIG. 10 illustrates exemplary accounting back office services provided by the Digital-T system. According to one embodiment, all Digital-T system components generate events that are collected and analyzed to allow for billing, auditing, capacity planning, and miscellaneous reporting.

In one embodiment of the invention, the Digital-T system accounting mechanism is built upon the IPDR “Network Data Management—Usage (NDM-U)” framework and record format.

In particular embodiments, the NDM-U framework specifies:
(1) An XML Schema that can be extended by a vendor. The schema may be simple, comprising a header and a trailer—a very high level (two field) representation of a data record.
(2) A compact encoding implementation of the XML schema, based upon XDR.
(3) A reference model that defines a set of interfaces over which IPDRs may be exchanged.

In various embodiments, each data element in an IPDR is placed into one of five categories:

| Category | Element Name | Example |
|---|---|---|
| Who | User ID responsible for the usage. | Retailer ID, Content Owner ID. |
| When | Event time. It there is a measurable difference | End of download transmission. |
| | between the start time and the end time, the | |
| | end time is used. | |
| What | Identifies the data that was associated with the | Content ID, Listing ID. |
| | event. | |
| Where | Location where event was triggered. | IP address of server reporting the |
| | | event. |
| Why | Event trigger type. | Type or event: sale, download, |
| | | etc. |

Functional Summary—Accounting/Financial Back-Office

| Function | Purpose |
|---|---|
| Event Collection | Collect raw exchange events. |
| Event Correlation | Match and correlate related events. |
| | Normalize data for use by |
| | downstream systems. |
| Aggregation/Splits | Organize billing items into accounts. |
| Rating/Invoicing | Apply rate information and generate invoices. |
| Netting/Clearing | Clear open balances, collect funds, net out. |

Generating and Collecting the Records

In one embodiment of the invention, the Digital-T system component that processes the request generates an IPDR and writes it to a local disk. The record is transmitted to the Business Support System (BSS) when it (the BSS) is available. In various embodiments:

1. The server that processes a request generates an IPDR.

2. The server writes the IPDR to a disk file.

3. An independent service picks up the IPDR files and pushes them to the BSS using the IPDR “D” interface.

4. When the IPDR has been acknowledged by the BSS, the service deletes the disk file.

5. If the BSS is unavailable, and there are records to send, the service will retry its connection on a configurable basis.

Record Collection

In one embodiment of the Digital-T system, the BSS is responsible for collecting the IPDRs from around the network and providing an analysis of the system's activity and performance. One immediate challenge in processing the IPDRs is that several components may be used to create the records and, accordingly, the records might not arrive in the correct order. To ensure that records are not lost, all records may be immediately written to a holding area (this may be, for example, a relational database table) where they wait for prerequisite data to arrive and be processed.

System operators manage the hold table to make sure that records do not languish there (which may indicate a potential problem somewhere in the network). In various embodiments, the “Validate Order” does not have a holding area because it typically does not need to wait for any prerequisite data to arrive. In particular embodiments, the records are collected into a normalized structure that represents the relationship between orders, line-items, bundles, and tracks. The records are eventually stored in a database (e.g., a denormalized relational database).

In various embodiments, the order of precedence in processing IPDRs is as follows:

1. Validate Order

2. Complete Order

3. Download Order

4. License Issue

5. Refund

In various embodiments, the various records are collected as follows:

1. The accounting server determines the type of IPDR being processed.

2. If the IPDR is for a validate-order:
(a) The system immediately creates new records in the accounting tables and partially populates them based upon the IPDR data;
(b) The accounting record is uniquely identified by the validation ID and line item within the order; and
(c) The accounting records have a rating indicator of “not rated”.

3. If the IPDR is for a complete order:
(a) The system extracts the validation identifier and line item number;
(b) If there are records in the transaction and line-item tables with the same validation identifier and line item, the system uses the IPDR record to further populate those records; and
(c) If there is not a record in the transaction/line-item tables with the same validation identifier and line item, the system stores the IPDR data in the PURCHASE_HOLD table.

4. If the IPDR is for a download order:
(a) The system extracts the validation identifier and line item number.
(b) If there are no records in the transaction and line-item tables with the same validation identifier and line item, the system stores the IPDR data in the DOWNLOAD_HOLD table.
(c) If there are records in the transaction and line-item tables with the same validation identifier and line item, the system attempts to locate a DOWNLOAD record with the same download UUID.
(d) If such a record is found, the current record is ignored (duplicate transmission).
(e) If a matching record is not found, the incoming record is processed as described below.
(f) The system inserts the download data into the download table;
(g) The system increments the download count in the corresponding record in the track table.
(h) If the download time (from the incoming record) is newer than the “last download time” in the track table, the system sets the “last download time” to the download time from the current record.

5. If the IPDR is for a license issue:
(a) The system extracts the validation identifier and line item number.
(b) If there are not records in the transaction and line-item tables with the same validation identifier and line item, the system stores the IPDR data in the LICENSE_HOLD table.
(c) If there are records in the transaction and line-item tables with the same validation identifier and line item, the system attempts to locate a LICENSE record with the same license issue UUID.
(d) If such a record is found, the current record is ignored (duplicate transmission).
(e) If a matching record is not found, the incoming record is processed as described below.
(f) The system inserts the license data into the license table.
(g) The system increments the license issue count in the corresponding record in the track table.
(h) If the license issue time (from the incoming record) is newer than the “last license issue time” in the track table, the system sets the “last license issue time” to the issue time from the current record.

6. If the IPDR is for a refund:
(a) The system immediately creates new records in the accounting tables and populates them based upon the IPDR data.
(b) The accounting records have a rating indicator of “not rated”.

7. Periodically, the system checks the _HOLD tables to see if data in them can be entered in to the accounting table.

8. Periodically, the system checks the _HOLD tables to see if data in them has exceeded a configurable age threshold. The system generates alarms for these data elements.

Rating

In one embodiment of the invention, the Digital-T system assigns an actual wholesale price to each sale. In particular embodiments, the wholesale price that is indicated in the sale record is the largest amount that the retailer will pay. Volume discounts are calculated at the end of the business period (typically a month).

In various embodiments, the rating algorithm is as follows:

1. The rating algorithm takes a start date/time and an end date/time as parameters.

2. The system determines all the applicable sales in the specified period and orders them by date/time of sale.

3. For each sale, the system locates the Wholesale Price Schedule that was used.

4. The system increments an in-memory (or temporary table) count of the number of sales of the item made by the retailer.

5. If the wholesale price is a fixed value (or a fixed percentage of a base value), the fixed value is used as the wholesale price and the record is marked as rated.

6. If the wholesale price is based on a volume schedule, the system looks at the in-memory counter and determines the price break, if possible, based upon the incremental sale.

7. If the wholesale price is based on a percentage of the actual retail price, the rating applies the particular business rule as agreed upon by the content owner and the retailer. For example, if a content owner requires to be paid either their wholesale listed price or 70% of the actual retail price, the algorithm will calculate 70% of the actual retail price and compare it to the listed wholesale price to determine the actual wholesale price owed to the content owner by the retailer.

8. If it is not possible to determine the price based upon the incremental sale, the item is placed on a queue for end-of-run processing (this occurs if the price of all items is based upon the total sold in a month).

9. At the end of the rating process, the system rates all queued items based upon the total number of the item sold by the retailer.

Aggregation

In one embodiment of the invention, the Digital-T system aggregates accounting data on a daily basis into a second database table. This second table may be considerably smaller than the line item table and makes for much faster summary reporting. In particular embodiments:

1. The accounting system aggregates data on a per-Content Item/Retailer/Day basis.

2. The accounting system maintains the line item detail records.

3. The system aggregates the daily data on a per-Content Item/Retailer/Month basis.

4. The accounting system maintains the daily-aggregation records.

Reporting

Exemplary usage and settlement reporting run from the Digital-T accounting systems includes:

1. Content Owner Sales Report
(a) Detailed—shows individual sales, maximum reporting window of 31 days;
(b) Daily Aggregated—does not show individual sales, data is summarized on a per day basis, maximum reporting window of 90 days;
(c) Monthly Aggregated—does not show individual sales, data is summarized on a per month basis, no maximum window;

2. Retailer Sales Report
(a) Detailed—shows individual sales, maximum reporting window of 31 days.
(b) Daily Aggregated—does not show individual sales, data is summarized on a per day basis, maximum reporting window of 90 days.
(c) Monthly Aggregated—does not show individual sales, data is summarized on a per month basis, no maximum window.

3. The Retailer Refund Report
(a) Detailed—shows individual refunds, maximum reporting window of 31 days.
(b) Daily Aggregated—does not show individual refunds, data is summarized on a per day basis, maximum reporting window of 90 days.
(c) Monthly Aggregated—does not show individual refunds, data is summarized on a per month basis, no maximum window.

4. The Affiliate Sales Report
(a) Detailed—shows individual sales, maximum reporting window of 31 days.
(b) Daily Aggregated—does not show individual sales, data is summarized on a per day basis, maximum reporting window of 90 days.

5. Monthly Aggregated—does not show individual sales, data is summarized on a per month basis, no maximum window.

Settlement Reporting

In one embodiment of the invention, the Digital-T system settlement reporting runs on a monthly basis. The reporting shows each customer (and the exchange operator) how much is owed/due from each of the other entities. Settlement reporting is run once by the system. The following description covers settlement reporting functionality in an exemplary embodiment of the invention:

1. An exchange operator initiates the settlement report generation using a command line tool.

2. The parameters to the settlement report area start date/time, an end date/time, and/or a name, e.g., “July 2004.”

3. The system checks that there are no reports in the settlement report table with the specified name (in various embodiments, such reports must be removed manually and then the settlement reporting task can be restarted).

4. The system checks that all sales in the period have been rated.

5. If any sales have not been rated, the rating process is run for the entire period.

6. The system generates a summary report for each content owner, retailer, and affiliate.

7. For content owners, the report details: (a) number of items sold by retailer; (b) total owed by each retailer; (c) number of promotional distributions by affiliate; (d) total owed to each affiliate; and (e) total owed to the exchange.

8. For retailers, the report details: (a) number of items sold by content owner; (b) total owed to each content owner; (c) number of referrals by affiliate; (d) total owed to each affiliate; and (e) total owed to the exchange.

9. For affiliates, the report details: (a) number of promotional distributions by content owner; (b) total owed by each content owner; (c) number of referrals by retailer; (d) total owed by each retailer; and (e) total owed to the exchange.

10. Each report is stored as an XML document in the SETTLEMENT_REPORT table (indexed by CUSTOMER_ID and report name).

11. When the report is initially stored, the AVAILABLE flag is set to false.

12. Once an exchange operator has approved the report, the AVAILABLE flag is set to true.

13. The system allows users with the cust-view-report capability to search for their settlement reports by name.

14. The system does not allow a user to see a settlement report until it has been reviewed and marked as available.

Service Provider/Retailer Billing Feed

In one embodiment of the invention, for Retailers in the Digital-T system that follow the communication service provider model, the system pushes IPDRs on a nightly basis directly to the service provider. In particular embodiments, the communication service provider may bill their customers without exposing the exchange to each customer's billing cycle.

In certain embodiments, it is likely that some service providers will be unable to accept IPDRs and in these cases customer-specific integrations will be implemented on a negotiated basis.

There are a few basic requirements that may be met to keep the externally facing IPDR records in line with other IPDR standards:

1. Each IPDR may have a serviceProviderID set to the fixed value “Digital-T”.

2. The listenerID may be renamed to subscriberID in the externally facing IPDR.

Content Owner Real-Time Feed

In one embodiment of the invention, the Digital-T system enables content Owners, or other third parties, to subscribe to a real-time sales feed. This functionality allows the Content Owner to monitor the demand for new content items. In particular embodiments, the feed will include IPDRs pushed out on a short-batch (5-10 minute) basis. In certain embodiments, it is likely that some content owners will be unable to accept IPDRs and in these cases customer-specific integrations will be implemented on a negotiated basis.

Exemplary ways to deliver the Real-Time Feeds:

1. Third Part De-aggregator: All records are passed to a third party who manages the distribution to subscribers.

2. Filtering: Feed subscribers have a set of feed filters in their profile and the back-office system will manage the filtering of data. An example would be to allow a content owner to receive feeds only for new releases, or for a specific title, or a specific artist.

3. Scrolling View: Subscribers log into an exchange functionality that shows a scrolling view of their feed allowing the Content Owner to receive the data feed without having to run servers to capture the data.

Automated Settlement

In one embodiment of the invention, the Digital-T system provides for automatic settlement. The Digital-T exchange accounting system can be used as a basis for automatic settlement. The settlement mechanism in the U.S. may use the US ACH. In other countries, the national electronic funds transfer, if available, may be used. The remainder of this description is based upon the US implementation.

In various embodiments, the clearing system may support:

1. A time period which, once passed, provides a high probability that funds are good (in the US, this may be, for example, 3 business days).

2. A time period which, once passed, provides a guarantee that funds are good (in the US, this may be, for example, 90 business days).

3. (As an alternative to 1 and 2) A positive acknowledgement that funds are good.

4. A “charge-back” indication that tells the exchange that a previous transfer attempt was rejected.

In various embodiments, the exchange sets up two (real) bank accounts, an exchange account and a settlement account. In particular embodiments, the Exchange Account holds the exchange balance—the profits, and the Settlement Account is used as the transfer point for funds to and from the Customers and the Exchange Account. One of the purposes of the settlement account is to hide the exchange account from the customers (all customers will see the settlement account number on their bank statements). A rogue customer will know the settlement account number but will never know the exchange account number.

Customers set up a settlement account to hide their own primary accounts from the exchange.

The automated settlement logic picks up when the settlement reporting is complete. The Content Owners and Affiliates have been provided with reports showing how much the exchange owes them. The Retailers have been provided with reports showing how much they owe the exchange. This logic describes the basis of a system that can interoperate with the ACH. Adherence of the current NACHA rules, is implemented.

Other Considerations—Downloads

Mechanical License/Constructive Receipt Considerations

In various embodiments, Digital-T is designed to manage potential issues surrounding the legal definition of constructive receipt of a mechanically licensed good. Constructive receipt typically occurs when a downstream distributor takes possession of a recording (typically multiple copies of a recording). Typically, when this occurs, royalty payments are due to publishers and other upstream actors (See Music Business Domain Model, Appendix B). In some cases constructive receipt can be interpreted to mean royalties are due before any revenue has been generated or collected. Given that revenue generation typically occurs at the time of sale (there is no “inventory”, per se), Digital-T provides configurations for managing constructive receipt issues.

The following demonstrate various possible business scenarios:

Case 1: Constructive receipt is not an issue. The location and ownership of one or more of the following systems is completely flexible: (a) DAM/CM attached system; (b) content repository; (c) content repository proxies; and (d) download servers.

Case 2: Constructive receipt is loosely interpreted to mean that royalties are due at the time a copy is made. Again, the location and ownership of the following systems may be completely flexible as above.

In this case, strictly speaking, the content owner may need to compensate the publisher for any “master” copies that reside in the download servers and possibly in the content repository if they own and operate those systems.

Case 3: Constructive receipt is tightly interpreted to mean that a royalty or bulk royalty payment is due at the point where content “leaves the CO”, regardless of the number of copies made at that time. In this case, the legal ownership may need to reside with the content owners, as in that way the content will not “leave the system” until each sale occurs. Put another way, the CO becomes the point of fulfillment and download, and the exchange simply handles the listings and matching.

Depending on the details of the situation, the location and operation of the systems can be flexibly provided as a shared service outsourced by the COs, or in the limit can be provided by the COs themselves.

In certain embodiments, all the above contingencies may be handled by the Digital-T architecture without additional design.

Promotions

Multiple features across the exchange service platform support promotions, which are typically short-term changes to exchange processes in order to market and sell titles under special circumstances. Some examples of promotions include:

(a) A concert tour by an act with new listings: content owners want to promote the tour by releasing promotional versions of the new titles, by lowering wholesale prices in the tour venues for a week before the concert appearance, and by supplying promotional material to affiliates with a territorial connection to the tour or an affinity connection to the act.

(b) After holiday season: drop wholesale prices on the worst-selling 50% of listings for the month of January.

Exemplary tools available for promotions are presented below, by service area.

| Area/Tool | Purpose | Examples |
|---|---|---|
| Content Owners | | |
| Dynamic pricing | Content owners can change | Create new wholesale price |
| | wholesale and suggested retail prices | schedule and apply to many |
| | for titles (in various embodiments, | listings. |
| | the content owners may do this | Change existing schedule in one |
| | substantially without restriction and | place; apply to all bound titles. |
| | with great flexibility.) | |
| Download rules | Define, for example, dates, counts, | Allow all titles by a given artist to |
| | and other rules for downloading | be downloaded unlimited times |
| | titles. | during a date range. |
| | | Allow title to be downloaded free |
| | | by first 300 listeners. |
| Territoriality and | In various embodiments, distribution | Create special promotions for |
| Exclusivity | rules may be used to restrict title(s) | favored retailers. Create special |
| | to a particular locale or set of | promotions for cities in a tour. |
| | retailers. | |
| Retailers | | |
| Packages | May be used to group together titles | Put best-selling titles in one |
| | for presentation to listeners. | package. |
| | | Bundle hot titles with lower- |
| | | performing inventory. |
| | | Create promotional specials. |
| Affiliates | | In various embodiments, affiliate |
| | | sites can be organized by act, by |
| | | geography, by genre, or for special |
| | | purposes such as tours and/or |
| | | seasonal activity. |
| Promotional | May allow listeners to download | |
| downloads | promotional content. | |
| Promotional | May allow listeners to follow | |
| references | affiliate referral link. Link may be | |
| | source coded by affiliate in order to | |
| | provide affiliate incentive. | |
| Reporting/Statistics | May measure effectiveness of | |
| | promotions (e.g., through reporting | |
| | keyed to retailer, price schedule, | |
| | and/or date). | |

Exemplary Distribution and Use Scenario Supported by the Digital-T System

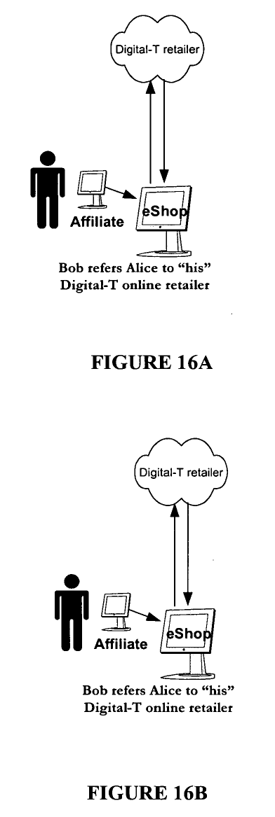

FIGS. 16A and 16B illustrate exemplary distribution and use scenario supported by the Digital-T system. In various embodiments, the system supports common digital distribution business models. Since the system is constructed as a modular, services-based system, support for many other models is possible.

The following exemplary scenario illustrates one way a system according to a particular embodiment of the invention can be used to deliver a value-added digital music service. In this embodiment, the system may preserve the content owner's business role without ceding market power to the distribution chain or intermediating services.

1. Listener A receives an electronic mail message from another Listener B with a list of digital works recently purchased from a music service. Listener A is familiar with many of the digital works that Listener B has purchased, but not the one from Author X. In a sense, Listener B is acting as a referral service for Listener A.

2. Listener A indicates that they would like more information on the digital work by Author X (e.g., by selecting an appropriate link within the e-mail message). In response to Listener A making this indication, Listener A is directed to a music download service located on the Internet. The music download service enables Listener A to the browse “The Catalog” (e.g., on the music download service's web site). In various embodiments, “The Catalog” is a virtual catalog including music from multiple providers of digital works that is indexed and accessible to system users. In one embodiment, a “virtual catalog” may include the individual catalogs of the participating labels.

3. Listener A is provided an opportunity to assemble a customized bundle of individual digital works (e.g., by selecting the individual works on the music download service's website). In one embodiment of the invention, the price of each individual digital work is displayed adjacent the title of the digital work.

4. Upon finalizing the customized bundle, Listener A proceeds to a payment module to select a payment instrument of choice. Listener A then authorizes payment for the total cost of the purchased digital works and specifies their preferred format for the digital works. Listener A requests the digital works in multiple formats, with options for using multiple devices.

5. At this point, Listener A's computer automatically connects to the content owners' servers that manage the titles for Listener A. (For example, Listener A may be directed to the (1) correct label, and/or (2) the retailer that has been designated by that label to serve that territory and/or Alice's account. This capability may, for example, allow the labels to maintain distribution in multiple geographies and retain tighter control over their catalogs.) Once Listener A is connected to the content owner's servers, a variety of value added services may be delivered, which may include:
a. high-speed download of the song in a preferred file format and encoding (e.g., bit rate),
b. file renaming and re-tagging according to user-specified preferences,
c. download artist and song information such as cover art, artist information, concert listings, etc.,
d. linking to related titles on the same album, back catalog, similar artists in the genre,
e. linking to merchandising up sell and to other artist-related materials,
f. downloading an electronic certificate that documents that Listener A has purchased rights to the purchased works,

Variations on this example include:

1. The system may be configured to allow Listener A to initiate the Digital-T “lookup” for songs the listener already has on their desktop. By clicking “lookup”, Listener A can proactively request the upgrade opportunities offered in Step 5, above.

2. Listener B can join an affiliate program in which he is rewarded for driving traffic to the music download service's web site. Bob can then use his weblog site as a Deejay site without fear of repercussions and without complicated rights clearing. In various embodiments, the Digital-T system has the ability to generate and track unique signatures for each affiliate—essentially providing the “referring-URL” function for media files.

In one embodiment, the Digital-T platform provides transparency for listeners. In the example above, while Listener A initiates a service by requesting content from the label (e.g., via the Verizon music store), the Digital-T platform is the reference point for initiating services (provided by the corresponding content owners and retailers). In one embodiment, on receipt of a service request, the label uses the Digital-T platform to service the request.

### CONCLUSION

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended exemplary concepts. Although specific terms are employed herein, they are used in a generic and descriptive sense only and not for the purposes of limitation.

We claim:

1. A method of distributing electronic media files, said method comprising the steps of:
providing a set of electronic media files at a central electronic media exchange;
establishing a first class of customers;
establishing a first set of contractual terms according to which said first class of customers will be allowed to purchase copies of said electronic media files from said electronic media exchange;
establishing a second class of customers;
establishing a second set of contractual terms according to which said second class of customers will be allowed to purchase copies of the electronic media files from said electronic media exchange;
selling copies of said electronic media files to at least one customer within said first class of customers according to said first set of contractual terms; and
selling copies of said electronic media files to at least one customer within said second class of customers according to said second set of contractual terms.

2. The method of claim 1, wherein said first class of customers comprises a first plurality of retailers.

3. The method of claim 2, wherein said second class of customers comprises a second plurality of retailers.

4. The method of claim 1, wherein said step of establishing a first set of contractual terms comprises establishing a first set of contractual terms according to which said first class of customers will be allowed to purchase copies of said electronic media files for resale.

5. The method of claim 4, wherein said step of establishing a second set of contractual terms comprises establishing a second set of contractual terms according to which said second class of customers will be allowed to purchase copies of said electronic media files for resale.

6. The method of claim 5, wherein said first set of contractual terms is different from said second set of contractual terms.

7. A method of providing a set of electronic media files, said method comprising the steps of:
providing a set of electronic media files at a central electronic media exchange;
allowing a first retailer to sell transmissions of said electronic media files from said central media exchange via a first front end; and
allowing a second retailer to sell transmissions of said electronic media files from said central media exchange via a second front end.

8. The method of claim 7, further comprising the step of, in response to a first file being purchased for transmission via said first front end, associating a first set of source-identifier data with said first file, said first set of source-identifier data identifying said first retailer as a source of said first file.

9. The method of claim 8, further comprising the step of, in response to said first file being purchased for transmission via said first front end, associating, with said first file, a first set of usage rules established by said first retailer, said usage rules being used to limit the usage of said first file after said first file is transmitted via said first front end.

10. The method of claim 7, further comprising the step of, in response to said first file being purchased for transmission via said first front end, associating, with said first file, a first set of usage rules established by said first retailer, said usage rules being used to limit the usage of said first file after said first file is transmitted via said first front end.

11. The method of claim 10, further comprising the step of, in response to a second file being purchased for transmission via said second front end, associating, with said second file, a second set of usage rules, said second set of usage rules having been established by said second retailer and being used to limit the usage of said second file after the second file is transmitted via said second front end.

12. The method of claim 8, further comprising the step of, in response to a second file being purchased for transmission via said second front end, associating a second set of source-identifier data with said second file, said second set of source-identifier data identifying said second retailer as a source of said second file.

13. The method of claim 12, further comprising the step of, in response to a second file being purchased for transmission via said second front end, associating, with said second file, a second set of usage rules, said second set of usage rules having been established by said second retailer and being used to limit the usage of said second file after the second file is transmitted via said second front end.

14. A method of distributing electronic media files, said method comprising the steps of:
providing a first set of electronic media files at a central electronic media exchange, said first set of electronic media files being owned by a first media owner;
providing a second set of electronic media files at a central electronic media exchange, said second set of electronic media files being owned by a second media owner;
allowing said first media owner to establish a first set of rules according to which copies of each of said first set of electronic media files will be sold to retailers for transfer from said central electronic media exchange;
allowing said second media owner to establish a second set of rules according to which copies of each of said second set of electronic media files will be sold to retailers for transmission via said central electronic media exchange;
selling, according to said first set of rules, a copy of at least one of said first set of electronic media files to a first retailer for transfer from said electronic media exchange; and
selling, according to said second set of rules, a copy of at least one of said second set of electronic media files to a second retailer for transfer from said electronic media exchange.

15. The method of claim 14, wherein said first set of rules comprises: (1) a first subset of rules according to which copies of one or more of said first set of electronic media files will be sold to a first set of retailers for transfer from said central electronic media exchange; and (2) a second subset of rules according to which copies of one or more of said first set of electronic media files will be sold to a second set of retailers for transfer from said central electronic media exchange.

16. The method of claim 15, wherein said first and second subsets of rules are defined by said first media owner.

17. The method of claim 15, wherein said first and second sets of customers are defined by said first media owner.

18. The method of claim 15, wherein said second set of rules comprises: (1) a third subset of rules according to which copies of one or more of said second set of electronic media files will be sold to a third set of retailers for transfer from said central electronic media exchange; and (2) a fourth subset of rules according to which copies of one or more of said second set of electronic media files will be sold to a fourth set of retailers for transfer from said central electronic media exchange.

19. The method of claim 18, wherein:
said first and second subsets of rules are defined by said first media owner; and
said third and fourth subsets of rules are defined by said second media owner.

20. The method of claim 19, wherein:
said first and second sets of customers are defined by said first media owner; and
said third and fourth sets of customers are defined by said second media owner.

21. The method of claim 18, wherein:
said first and second sets of customers are defined by said first media owner; and
said third and fourth sets of customers are defined by said second media owner.

22. A method of distributing electronic media files, said method comprising the steps of:
providing a set of electronic media files at a central electronic media exchange, said set of files being owned by a media owner;
allowing a first retailer to sell transfers of one or more of said set of electronic media files from said central media exchange via a first front end;
allowing a second retailer to sell transfers of said electronic media files from said central media exchange via a second front end;
reporting, to said media owner in real time, data indicating how many copies of each of said set of electronic media files has been sold by said first retailer within a particular period of time; and
reporting, to said media owner in real time, data indicating how many copies of each of the set of electronic media files has been sold by said second retailer within said particular period of time.

23. The method of claim 22, wherein:
said set of electronic media files is a first set of electronic media;
said front end is a first front end;
said media owner is a first media owner; and
said method further comprises:
providing a second set of electronic media files at said central electronic media exchange, said second set of files being owned by a second media owner;
allowing a first retailer to sell transfers of one or more of said second set of electronic media files from said central media exchange via said first front end;
allowing a second retailer to sell transfers of one or more of said second set of electronic media files from said central media exchange via said second front end;
reporting, to said second media owner in real time, data indicating how many copies of each of said second set of electronic media files has been sold by said first retailer within a particular period of time; and
reporting, to said media owner in real time, data indicating how many copies of each of said second set of electronic media files has been sold by said second retailer within said particular period of time.

24. A method of distributing electronic media files, said method comprising the steps of:
providing a set of electronic media files at a central electronic media exchange, said set of files being owned by a media owner;
allowing a first retailer to sell transfers of one or more of said set of electronic media files from said central media exchange via a first front end;
allowing a second retailer to sell transfers of one or more of said set of electronic media files from said central media exchange via a second front end;
reporting, to said media owner in real time, data indicating how many copies of each of said set of electronic media files has been sold by said first retailer within a particular period of time; and
reporting, to said media owner in real time, data indicating how many copies of each of said set of electronic media files has been sold by said second retailer within said particular period of time.

25. The method of claim 24, wherein said method further comprises allowing said media owner to change, in real time, a price associated with transferring at least one of said set of electronic media files via said first front end.

26. The method of claim 25, wherein said method further comprises allowing said media owner to change, in real time, a price associated with transferring at least one of said set of electronic media files via said second front end.

27. The method of claim 24, wherein:
said set of electronic media files is a first set of electronic media files;
said front end is a first front end;
said media owner is a first media owner; and
said method further comprises:
providing a second set of electronic media files at said central electronic media exchange, said second set of files being owned by a second media owner;
allowing a first retailer to sell transfers of one or more of said second set of electronic media files from said central media exchange via said first front end;
allowing a second retailer to sell transfers of one or more of said second set of electronic media files from said central media exchange via a second front end;
reporting, to said second media owner in real time, data indicating how many copies of each of said second set of electronic media files has been sold by said first retailer within a particular period of time; and
reporting, to said media owner in real time, data indicating how many copies of each of said second set of electronic media files has been sold by said second retailer within said particular period of time.

28. A method of distributing electronic media file, said method comprising the steps of:
providing, at a central electronic media exchange, a first copy of an electronic media file in a first format, and a second copy of said electronic media file in a second format;
selling a transfer of said first copy of said media file to a customer for a first price;
after selling said transfer of said first copy of said media file to said customer, receiving a request by said customer to receive a second copy of said electronic media file;
in response to receiving said request, confirming that said first customer purchased said first copy of said media file; and
in response to confirming that said customer has purchased said first copy of said media file, providing said second copy of said electronic media file to said customer.

29. The method of claim 28, wherein said step of providing said second copy of said electronic media file to said customer comprises providing said second copy of said electronic media file to said customer for a price that is lower than said first price.

30. The method of claim 28, wherein said step of providing said second copy of said electronic media file to said customer comprises providing said second copy of said electronic media file to said customer for substantially no additional consideration from said customer.

31. A method of distributing electronic media files, said method comprising the steps of:
providing a first set of electronic media files at a central electronic media exchange, said first set of electronic media files being owned by a first media owner;
providing a second set of electronic media files at said central electronic media exchange, said second set of electronic media files being owned by a second media owner; and
allowing a retailer to bundle, for resale to customers: (1) a transfer, from said central electronic media exchange, of at least one of said first set of electronic media files; and (2) a transfer, from said central electronic media exchange, of at least one of said second set of electronic media files.
